(19) United States
(12) Patent Application Publication
(10) Pub. No.: US 2006/0003914 A1
(43) Pub. Date: Jan. 5, 2006

(54) Compositions comprising fabric softening active system comprising at least two cationic fabric softening actives

(76) Inventor: Gayle Marie Frankenbach, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/195,253

(22) Filed: Aug. 1, 2005

Related U.S. Application Data
(63) Continuation of application No. 10/461,773, filed on Jun. 13, 2003.
(60) Provisional application No. 60/388,227, filed on Jun. 13, 2002.

(51) Int. Cl. C11D 3/00

(52) U.S. Cl. 510/515

(57) ABSTRACT

Liquid fabric softening compositions generally comprise: (a) a fabric softening active system comprising at least two fabric softening actives, preferably cationic fabric softening actives, each having a recrystallization onset temperature; wherein the recrystrallization onset temperature of a first fabric softening active is at least about 5° C., preferably at least about 10° C., more preferably at least about 15° C., and even more preferably at least about 20° C., below the recrystallization onset temperature of a second fabric softening active; (b) liquid carrier, typically aqueous-based, to act as a continuous phase for the formation of a dispersion; and (c) optional ingredients.

### CROSS REFERENCE TO RELATED APPLICATIONS

This application is a continuation of U.S. application Ser. No. 10/461,773, filed Jun. 13, 2003 which claims priority under 35 U.S.C. § 119(e) to U.S. Provisional Application Ser. No. 60/388,227, filed Jun. 13, 2002, the disclosues of which are incorporated by reference.

### TECHNICAL FIELD

The present invention relates to aqueous textile treatment compositions. In particular, it relates to textile treatment compositions for use in the rinse cycle of a textile laundering operation to provide fabric softening/static control benefits, the compositions being characterized by improved absorbency, dispersibility, and perfume incorporation as well as excellent storage stability and excellent viscosity stability after freeze/thaw cycling.

### BACKGROUND OF THE INVENTION

Aqueous textile treatment compositions suitable for providing fabric softening and static control benefits during laundering are well-known in the art and have found wide-scale commercial application. Conventionally, aqueous, rinse-added, fabric softening compositions contain, as the active softening component, substantially water-insoluble cationic materials having two long alkyl chains. Typical of such materials are di-hydrogenated tallow di-methyl ammonium chloride and imidazolinium compounds substituted with two stearyl groups. These materials are normally prepared in the form of a dispersion in water. It is generally not possible to prepare such aqueous dispersions with more than about 10% cationic materials without encountering intractable problems of product viscosity and stability, especially after storage at lower temperatures, such that the compositions are unpourable and have inadequate dispensing and dissolving characteristics in rinse water. This physical restriction on softener concentration limits the level of softening performance achievable without using excessive amounts of product and also adds substantially to the costs of distribution and packaging. Accordingly, it would be highly desirable to prepare physically acceptable aqueous textile treatment compositions containing much higher levels of substantially water-insoluble cationic softener materials. Cationic softener materials are normally supplied by the manufacturer containing about 70%-90% of active material in an organic liquid such as isopropanol or ethanol, sometimes containing a minor amount of water (up to 10%). Retail fabric softening compositions are then prepared by dispersion of the softener in warm or hot water under carefully controlled conditions. The physical form and dispersibility constraints of these industrial concentrates are such as to preclude their direct use by the domestic consumer; indeed, they can pose severe processing problems even for the industrial supplier of retail fabric softening compositions.

Many of the various solutions to the specific problem of preparing aqueous fabric softening compositions, especially in concentrated form suitable for consumer use, have not been entirely satisfactory. For example, in U.S. Pat. No. 3,681,241, the presence of ionizable salts in softener compositions tend to help reduce viscosity, but this approach by itself is ineffective in preparing compositions containing more than about 12% of dispersed softener, inasmuch as the level of ionizable salts necessary to reduce viscosity to any substantial degree has a seriously detrimental effect on product viscosity stability.

Viscosity problems resulting from high concentrations of softening actives have been addressed with auxiliary additives such as paraffin oils and waxes, ethoxylated diamines, alkyl pyridine compounds, zwitterionics, betaines, water miscible solvents & extenders, fatty acids, hydrocarbons, aliphatic fatty acids, and fatty methyl esters, organic acids to concentrate and improve dispersibility as described in European Patent Nos. 0,085,933, by M. Adolf et al., 0,094,655 by H. Stuhler et al., 0,000,460 by Golbinet, and 0,013,780 by M. Verbruggen and U.S. Pat. No. 4,772,403 by J.-P. Grandmarie et al., U.S. Pat. No. 5,750,491 by F. DeBlock et al., U.S. Pat. No. 4,454,049 by Neil McGilp et al.

U.S. Pat. No. 5,468,398 discloses mixed actives to formulate stable concentrated dispersions based on mixing diamido amines or diester quats plus diester or diamide imidazolinium quats.

WO 95/16766 discloses the use of specific cosofteners to stabiliize concentrated formulation comprising biodegradable diester quaternary ammonium softening materials with low IV (e.g. IV<10).

### SUMMARY OF THE INVENTION

Now it is surprisingly discovered that by using medium to highly fluid fabric softener actives it is possible to form mixed active systems that are concentrated systems with improved beneftis such as better dispersibility and or increased absorbency, superior perfume incorporation, etc. Suprisingly it is now also found that it is possible to fomulate very stable concentrated mixed systems e.g. systems having desireably long-term viscosity characteristics especially after freeze/thaw cycling based on highly fluid systems provided the fluidity of at least one of the co-fabric softener actives used is sufficiently different from the fluidity of the primary fabric softener active system. Furthermore it is possible to concentrate these active/co-active systems without the aid of polymeric stabilizing agents (i.e. the compositions herein are preferably free of polymeric stabilizing agents). Moderately to highly fluid actives are actives with fluidity greater than that of a monoquat ammonium compound having unbranched hydrophobe(s) with an IV>=about 10 and this can be quantified by the transition temperature. A moderately to highly fluid fabric softening active has a recrystallization onset temperature, as measured by a DSC trace, of less than about 50° C.

The liquid fabric softening compositions of the present invention generally comprise:

(a) a fabric softening active system comprising at least two fabric softening actives, preferably cationic fabric softening actives, each having a recrystallization onset temperature; wherein the recrystrallization onset temperature of a first fabric softening active is at least about 5° C., preferably at least about 10° C., more preferably at least about 15° C., and even more preferably at least about 20° C., below the recrystallization onset temperature of a second fabric softening active;

(b) liquid carrier, typically aqueous-based, to act as a continuous phase for the formation of a dispersion; and

(c) optional ingredients.

The compositions can comprise from about 10% to about 95% of the fabric softener active system with at least about 0.1% total FSCA in the fabric softener active system.

All documents cited herein are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### BRIEF DESCRIPTION OF THE DRAWINGS

FIG. 1 is a graph of the results of a DSC analysis of a hard-tallow ditallowoylethylester dimethyl ammonium chloride (“DEEDMAC”), plotted in terms of Heat Flow (W/g) as a function of Temperature (° C.).

FIG. 2 is a graph of the results of a DSC analysis of a methyl bis(tallowarnidoethyl)-2-hydroxyethyl ammonium methyl sulfate (commercially available as VARISOFF 110), plotted in terms of Heat Flow (W/g) as a function of Temperature (° C.).

FIG. 3 is a graph of the results of a DSC analysis of a soft-tallow DEEDMAC, plotted in terms of Heat Flow (W/g) as a function of Temperature (° C.).

FIG. 4 is a graph of the results of a DSC analysis of a methyl bis(tallowamidoethyl)-2-hydroxyethyl ammonium methyl sulfate (commercially available as VARISOFT 222), plotted in terms of Heat Flow (W/g) as a function of Temperature (° C.).

FIG. 5 is a graph of the results of a DSC analysis of a dicanola-ethylester dimethyl ammonium chloride (“high-fluid DEEDMAC”), plotted in terms of Heat Flow (W/g) as a function of Temperature (° C.).

FIG. 6 is a graph of the results of a DSC analysis of a methyl bis(canola-amidoethyl)-2-hydroxyethyl ammonium methyl sulfate, plotted in terms of Heat Flow (W/g) as a function of Temperature (° C.).

### DETAILED DESCRIPTION OF THE INVENTION

### I. Compositions

The compositions of the present invention comprise a fabric softener active system that is comprised of a primary fabric softener active (PFSA) and a fabric softener co-active (FSCA) together with a liquid carrier, typically water. It is required that the FSCA have a recrystallization onset temperature that is measureably different from the PFSA. The compositions comprise from about 10% of the fabric softener active system with at least about 0.1% up to about 50% total FSCA in the fabric softener active system.

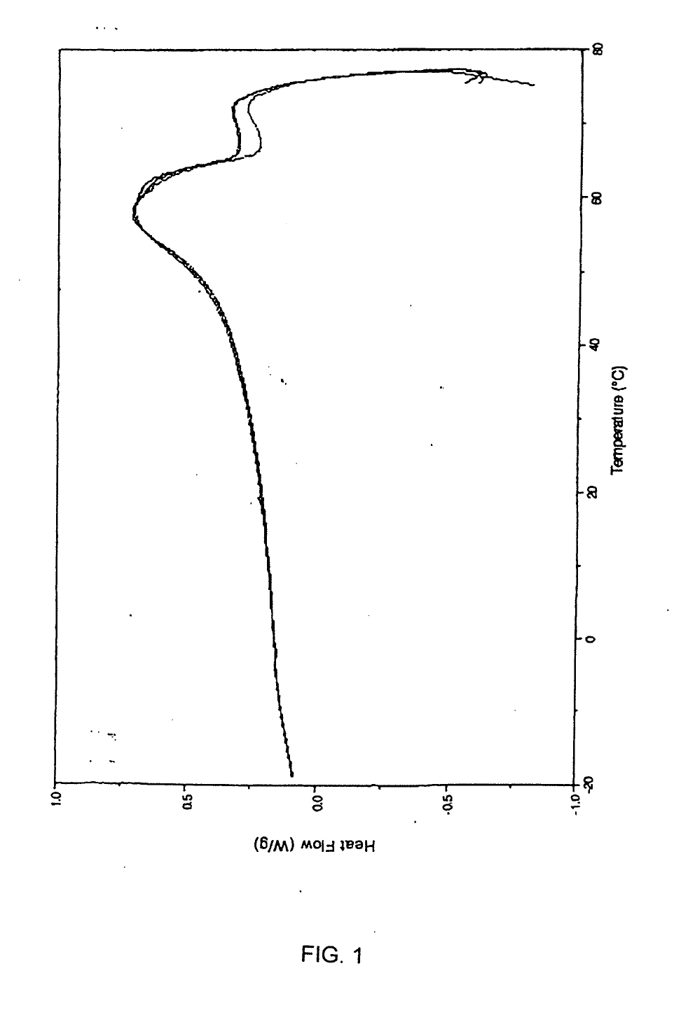

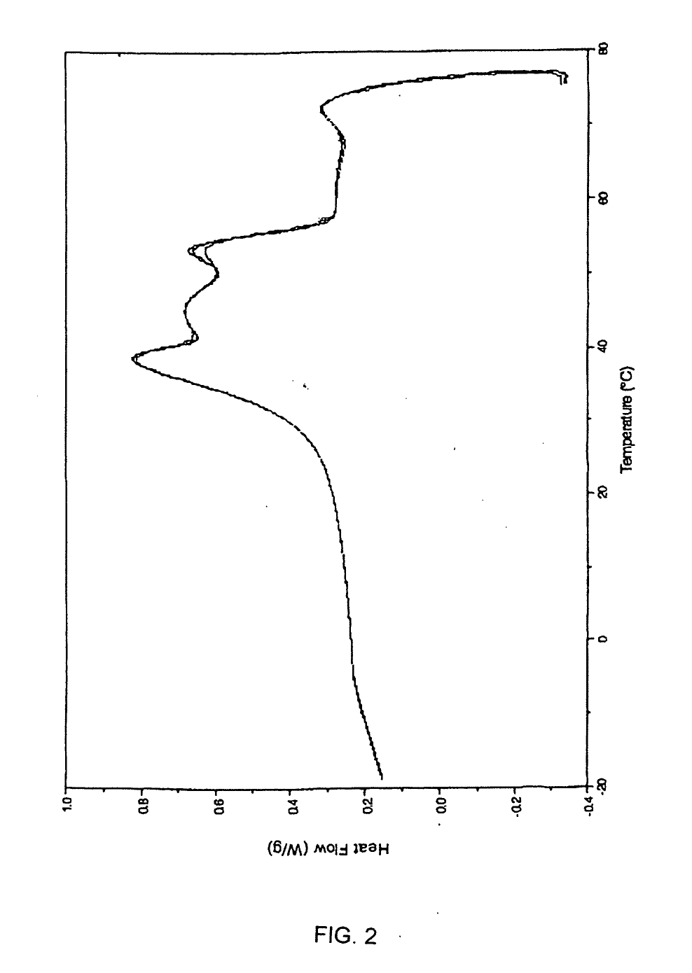

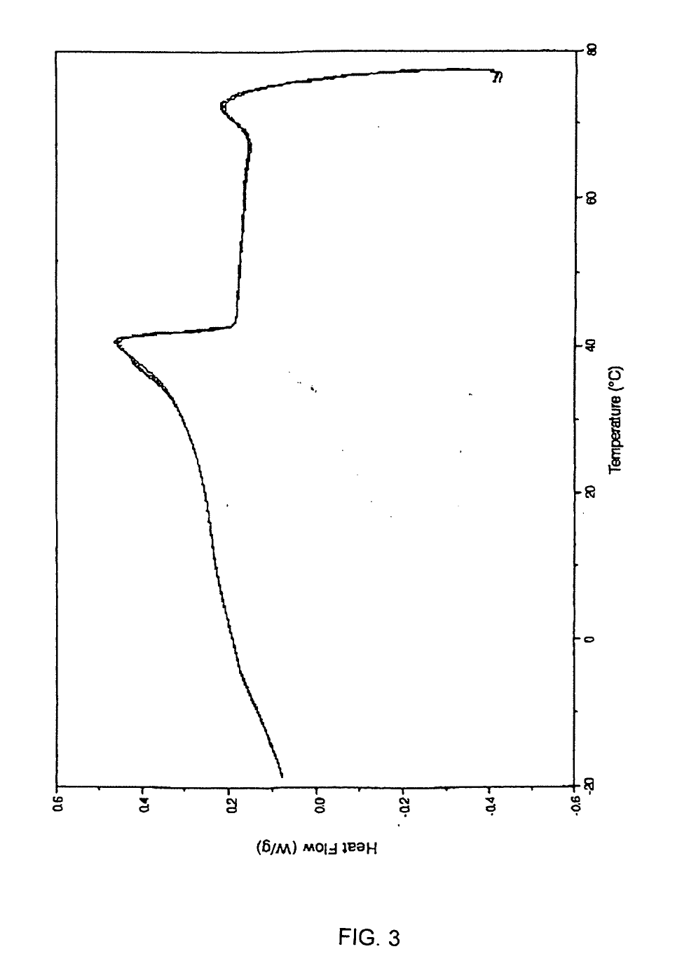

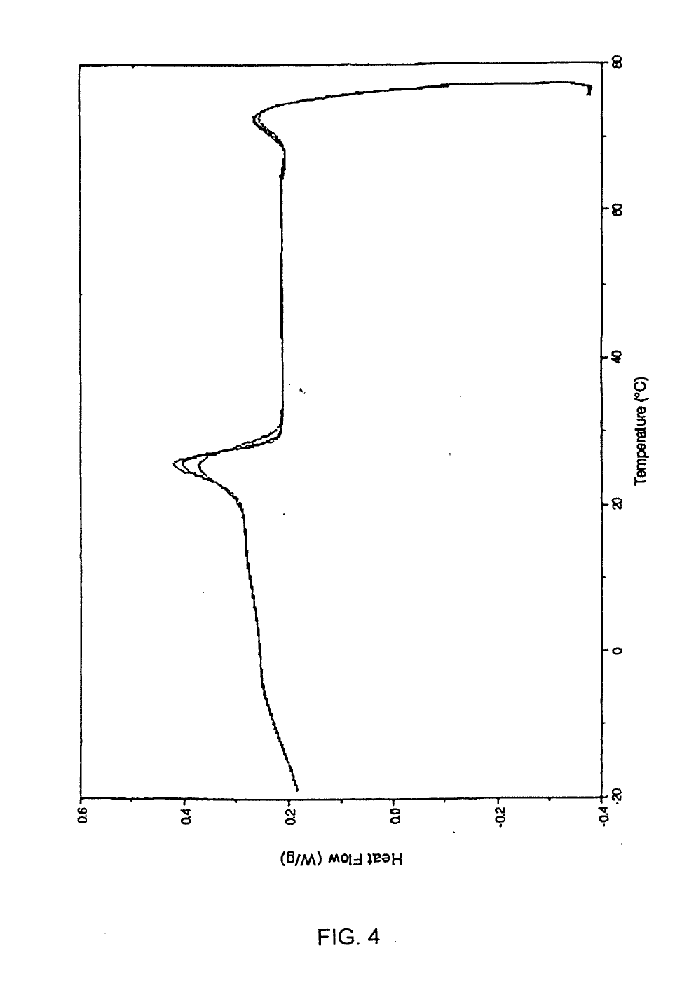

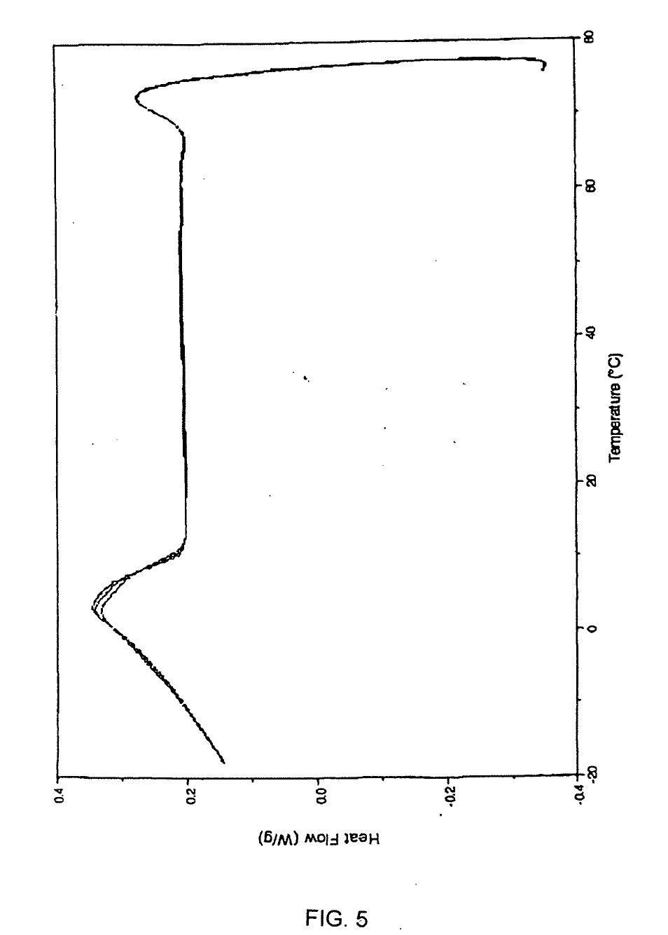

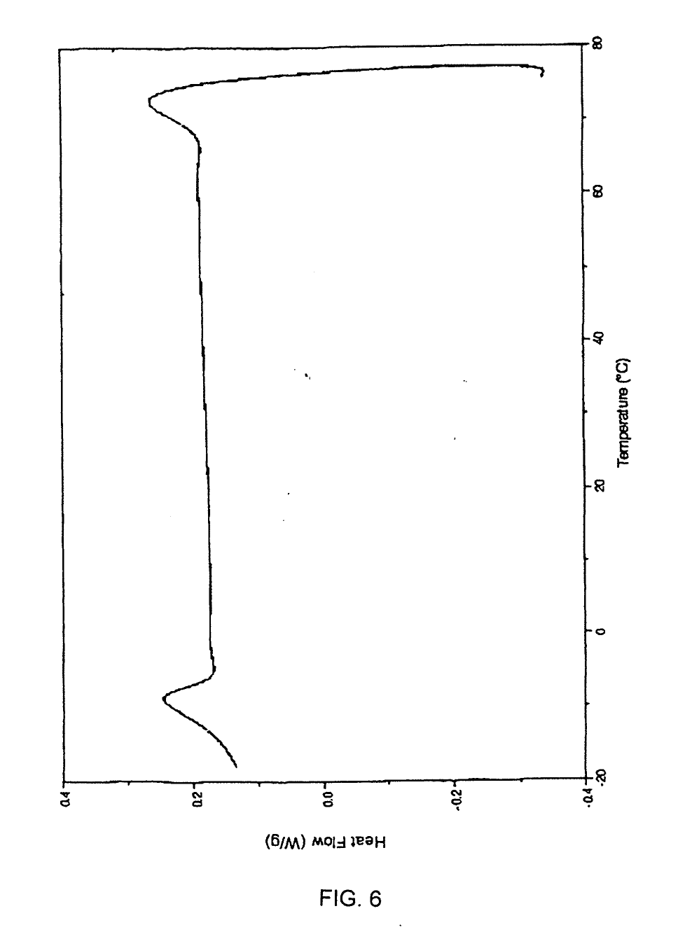

As used herein, the term “recrystallization onset temperature” refers to the temperature at which a material begins to recrystallize as measured via Differential Scanning Calorimetry analytical method as described herein. The recrystallization onset temperature of a fabric softening active relates to the “fluidity” of the softening active; generally, lower recrystallization onset temperatures correspond to softening actives exhibiting higher fluidity. FIGS. 1-6 show graphical results from DSC analyses for various fabric softening actives. The recrystallization onset temperatures for each fabric softening active tested are shown in FIGS. 1, 2, 3, 4, 5, and 6 at numeral references 10, 20, 30, 40, 50, and 60, respectively.

Mixed Fabric Softening Active System

The mixed fabric softener active system suitable for the present invention comprises at least two materials, a primary fabric softener active (PFSA) and at least one fabric softener co-active (FSCA). Other optional fabric softener active materials can be added as needed to the mixed-active fabric softener system.

The PFSA and the FSCA are based on materials with a nitrogen moiety (typically amine or ammonium) together with hydrophobic substituents also termed hydrophobes. The hydrophobes are typically, but not exclusively hydrocarbon-based substituents. A typical, but nonlimiting, acceptable structure for the PFSA and FSCA comprises at least one hydrophobe having at least about six carbons. Prefered structures for the PFSA and the FSCA have one to three hydrocarbon substituents with at least about six carbons. The most preferred PFSA and FSCA structure have two hydrocabon substituents with at least about six carbons and less than about 30 carbons. However, it is acceptable for both the PFSA and the FSCA to comprise multiple nitrogen-based species with differing numbers of hydrocarbon substituents.

It is acceptable for the hydrophobes to be saturated, unsaturated, branched, cyclic, linear, or any combination thereof. Acceptable hydrophobes, while typically and preferably hydrocabon-based may also be based on fluorocarbons or silicone compounds. It is acceptable for hydrocabon hydrophobes to be comprised entirely of carbon and hydrogen or for the hydrophobes to comprise non-carbon moieties, especially those based on nitrogen, oxygen, sulfur or phosphorous. Hydrophobes may be identical or different.

A preferred PFSA and/or FSCA comprises a quaternary amine with at least about two hydrocarbon substituents having at least about six carbons. It can be preferred for the PFSA and/or FSCA to comprise a quaternary amine with one hydrocarbon substituent having at least about six carbons Such mixtures of nitrogen-based materials with one and two hydrocarbon substituents having at least about six carbons are useful in situations in which surfactant carry-over is present and performance is improved when the surfactant carry-over is complexed by the nitrogen based material having one hydrocarbon substituent having at least about six carbons.

The present invention requires that either the PFSA or the FSCA has a fluidity measureably greater than the fluidity of dimethyl N,N′ di-(tallowoyl oxyethyl) ammonium chloride with an IV of about 10. For the present invention the term fluidity refers to the ability of the PFSA or the FSCA to flow at ambient temperatures. Fluidity is related to the recrystallization onset temperature of the fabric softening active. In general, the lower the recrystallization onset temperature of the softening active, the more fluid it is. Recrystallization onset temperatures for fabric softening. Preferably either the PFSA or FSCA has a mid-range fluidity which is a fluidity greater than a mono-quaternary fabric softerner active with an IV between about 10 and about 50 and more preferably the fluidity of either the PFSA or FSCA has a high fluidity which a is fluidity greater than a mono quaternary fabric softener active with an IV above about 50.

The table below exemplifies how DSC is used to classify fabric softening actives with linear hydrophobes having different levels of unsaturation into low, mid, and high fluid categories, based on the recrystallization onset temperatures of the materials.

| Fabric | | | |
|---|---|---|---|
| Softener | | | |
| Active | Fluidity | DSC Trace | FIG. |
| #1 | Low | recrystallization onset | 1 |
| | | temperature is about 65° C. | |
| #2 | Low | recrystallization onset | 2 |
| | | temperature is about 58° C. | |
| #3 | Medium | recrystallization onset | 3 |
| | | temperature is about 45° C. | |
| #4 | Medium | recrystallization onset | 4 |
| | | temperature is about 30° C. | |
| #5 | High | recrystallization onset | 5 |
| | | temperature is about 12° C. | |
| #6 | High | recrystallization onset | 6 |
| | | temperature is about −3° C. | |

1. Hard tallow DEEDMAC - ditallowoylethylester dimethyl ammonium chloride, IV = about 10.
2. Varisoft 110 - methyl bis(tallowamidoethyl)-2-hydroxyethyl ammonium methyl sulfate, IV = about 10.
3. Soft tallow DEEDMAC - ditallowoylethylester dimethyl ammonium chloride, IV = about 50.
4. Varisoft 222 - methyl bis(tallowamidoethyl)-2-hydroxyethyl ammonium methyl sulfate, IV = about 50.
5. Canola DEEDMAC - dicanola-ethylester dimethyl ammonium chloride.
6. Methyl bis(canola-amidoethyl)-2-hydroxyethyl ammonium methyl sulfate.

The present invention also requires that the recrystallization onset temperature of the FSCA be measureably different (either higher or lower) than the recrystallization onset temperature of the PFSA as measured via DSC analytical methods. When using DSC to measure recrystallization onset temperatures, the FSCA and the PFSA are considered to have distinct recrystallization onset temperatures when they differ by at least about 5° C. The chemical composition and even the chemical connectivity of the FSCA and PFSA can be identical or similar, but it is critical for the FSCA to have a recrystallization onset temperature that is measureably different from the PFSA as measured via DSC analytical methods.

Surprisingly it is found that a variety of performance and stability benefits are derived with the use of mixed-active systems that contain at least 5% of a PFSA or FSCA having a recrystallization onset temperature measureably greater than the recrystallization onset temperature of dimethyl bis (tallowoylethyl) ammonium chloride with an IV of about 10 including but not limited to: 1) improved stability, 2) improvements in absorbency, 3) improvements in dispersibility and uniform coverage, 4) improvements in color care, 5) improvements in wrinkle control, 6) improvements in perfume incorporation leading to improvements in perfume expression on fabrics. These benefits are described in further detail herein below.

Not to be bound by theory, but the PFSA or FSCA are typically more fluid when structural features of the molecule inhibit crystallization or solidification at ambient temperatures. Attention to a variety of structural features can provide guidance for choosing actives that are more fluid including, but not limited to the degree of unsaturation (often measured by IV). Each of the following parameters individually contributes to increasing the fluidity (as measured by a lower recrystallization onset temperature) of the PFSA or FSCA: counterions that disrupt crystallinity, head groupds that disrupt crystallinity, the presence of branching in the hydrophobic tails at least one tertiary/quaternary carbon is sufficient to increase fluidity, with fluidity increasing as the tertiary quaternary carbon is located farther from the end and closer to the middle of the hydrophobe and/or as the number of tertiary/quaternary carbons increases, reduced molecular symmetry, a reduction in the number of specific intra- and intermolecular interactions, recuction in the chemical homogeniety of the hydrocarbon based tail, and finally a reduction in the purity of the active. Combinations of the preceding parameters can also increase fluidity. Since fluidity is necessary for high performance benefits such as wrinkle, color care, absorbency, etc., when PFSA has an IV of about 10 or less, it can be important that the PFSA comprise one or more of the other structural features such that the fluidity becomes moderate or high as measured by the recrystallization onset temperature. Materials that have low IV and lack other structure features imparting fluidity generally tend to reduce the fluidity, dispersibility, static viscosity especially at extreme temperatures and freeze-thaw stability.

Benefits of the Mixed Fabric Softening Active Systems

Improved Stability

Not to be bound by theory, but the stability of a condensed material, such as a liquid crystalline particle or a vesicle is dependent on close packing. When close packing is lost in a condense phase, that phase becomes unstable and seeks to revert to a phase that allows close packing. Prefered PFSA and FSCA tend to be materials with two hydrocarbon groups of at least about six carbons, often chains and such materials tend to close pack in when these are arranged in flat sheets. However, is usual to form fabric softener active systems into vesicles, since vesicular dispersions have much lower viscosities vs. the natural liquid crystalline state of the actives and thus the dispersions pour and disperse more easily and are prefered for use by consumers. Unfortunately, when the di-hydrophobe quaternary species are forced by mechanical (or other) pressures to pack in curved vesicles, close packing is typically lost and resulting in a higher energy composition that tends, over time or when stressed (by temperature changes or other environmental factor), to revert to the lower energy form, but higher viscosity form, liquid crystalline sheets. Unfortunately, this reversion usually results in a high viscosity and typically very unsightly inhomogeneous composition which is difficult to use and even repulsive to the consumer thus degrading both the business opportunity and product reputation. (see the discussion on p 113 of Surfactant and Interfacial Phenomena by Milton J. Rosen 2^{nd} Ed. 1989 for a discussion of preferred packing geometries as a function of molecular structure parameters).

Surprisingly, it is found that it seems to be possible to alter the packing geometry of the vesicles by utilizing mixed active systems comprising a PFSA and a FSCA with measureably different fluidities. Not to be bound by theory, but when a PFSA and a FSCA having measureably different fluidities are mixed, it is possible to improve close packing in the vesicle and reduce the tendency for reversion to the liquid crystalline state which drives viscosity instability. Not to be bound by theory, but differences in fluidity between the PFSA and the FSCA seem to result in effective differences in geometry and when the geometries are adequately matched, close packing results which drives improved stability. This improved stability can be measured by resistance to increases in viscosity as a function of static storage at temperature extremes and/or resistance to increases in viscosity as a function of temperature cycling.

Improvements in Dispersibility and Uniform Coverage

As PFSA's and FSCA's are mixed to form more stable vesicles, it is typical for the initial viscosity to also be lowered which is especially important for concentrated products as this effect also provides improvements in dispersibility and uniform coverage. Not to be bound by theory, but as vesicles become more well packed these tend to be more compact and provide for greater dispersed phase volume. Since vesicles tend to be more compact, these are easier to separate during the making process and these tend to have less collisions of the type leading to coallescence on storage. Therefore, such compositions tend to dilute more readily into separate vesicles resulting both in better dispersion and through better dispersion, more uniform coverage on fabrics.

Improvements in Perfume Incorporation

Perfume is an ingredient that can be notoriously difficult to incorporate into fabric softener active systems, while maintaining a stable system, especially when the perfume is incorporated at higher levels (e.g. levels of at least about 1%, by weight of the composition). In systems that are less stable, this problem is exacerbated. Dispersions based on highly unsaturated actives are especially notorious for their inability to incorporate perfumes. Since aesthetic benefits are extremely important to the consumer acceptance of such compositions it is critical to the commercial success of these compositions to solve this problem. Surprisingly, we now find that it is possible to incorporate perfumes into mixed active compositions comprising actives that when used alone, form compositions that are difficult or impossible to incorporate pefume into. Even compositions that accept typical levels of perfume e.g. about 1% can become unstable when higher perfume levels, e.g. about 1.5% or more are incorporated into the dispersion composition. Suprisingly, we now find that many mixed active systems are capable of maintaining improved stability for longer periods of time while incorporating at least about 1.5% perfume.

Improvements in Absorbency

Typical fabric softener compositions are known to result in reduction of absorbency of fabrics that are naturally absorbent even when the fabric softener is used for as little as one cycle. Over multi-cycle usage, the lack of absobency becomes exacerbated. An exception to this behavior is seen with fabric softener systems that distributed poorly and thus spread non-uniformly over fabrics. In cases where fabric softener actives are spread non-uniformly over fabrics, the absorbency of the fabric is maintained, but at the cost of poor performance in softenening and other aspects that the fabric softener is expected to deliver. When fluid actives are used in mixed-active systems, actives can be uniformly distributed while maintaining more of the fabrics natural absorbency. Not to be bound by theory but when fluid actives are deposited on fabrics, the fluidity of these materials is such that the deposited materials are capable of moving aside to allow water to pass into the fabric. Alternately, it is also possible that these more fluid actives maintain a liquid crystalline structure upon deposition such that the ordered head groups can act as capillaries that transport water into the fabric. Examples of the effect of improved absorbency are given in Example 2.

Improvements in Color Care

While some typical fabric softeners dipsersions are know to provide benefits in color care, compositions of the present invention based on medium to high fluid actives can provide increases in color care. Not to be bound by theory, but PFSA and/or CFSA that have medium to high fluidity tend to spread more effecitvely over fibriles, fibers, and yarns vs. low fluid fabric softener actives. Medium to high fluidity materials also have higher lubricity capacity vs. low fluid actives. By spreading more effectively over fibrils, fibers, and yarns, and more effectively lubricating fibrils, fabrics, and yarns, the medium to high fluid PFSA's and CFSA's protect the fabric structure from damage due to abrasion. Not to be bound by theory, but when abrasion occurs, this can lead to visible pilling which diffuses light reflected off fabric resulting in a perceived reduction in color richness. Medium to high fluid PFSA's and CFSA's can also reattach fibrils that are seperating from fibers, thus helping to prevent the formation of pills. Finally the medium to high fluid fabric softener actives can reduce light diffusion at the surface by better matching the refractive index between the surface and the air, thus providing a deepening of the apparent color. Generally, the higher the % of highly fluid fabric softener active present in compositions of present invention, the greater the color care provided by the composition.

Improvements in Wrinkle Control

Mechanisms associated with medium to highly fluid PFSA's and CFSA's leading to improved lubricity disclosed above in section 1e. Improvements in Color Care also provide improvements in wrinkle control. Improving the lubricity of fibrils, fibers, and yarns leads to reduction in friction between the structures and thus eases the release of wrinkles in the fabric. Additionally, improved lubricity leads to reduced effort expended in ironing reduing both the time and work involved on the part of the consumer to remove wrinkles by ironing. In general, wrinkle control benefits are greater when the compositions of the present invention comprise a greater % of highly fluid fabric softener actives.

Fabric Softening Activities

The acceptable structures for the PFSA and the FSCA for the present invention are described in detail below. In general, preferred structures are amphiphilic comprising both a hydrophilic head group and hydrophobes. Prefered structures are typically, but not exlcusively quaternary amine compounds. Preferred structures typically contain two hydrophobes comprising at least about eight carbons each. Those skilled in the art will recognize that few commercially available materials are purely composed of one material. Within the art it is generally recognized that when a target structure is being synthesized, several side products are also generated. Therefore, so called prefered materials comprise side products as well as the target prefered material. Often when the target material is a material having at least about two hydrophobes comprising at least about eight carbons, a certain amount of side product is generated having only one such hydrophobes and/or three such hydrophobes. Also, when the target material is a quaternary ammonium salt, a certain amount of amine is left as a side product. Typically the prefered material (a quaternary ammonium salt with two hydrophobes each having at least about eight carbons) is present as one of the major products of the reaction and the entire material, comprising both the target material and side product is used as a mixture. The fluidity of the entire composition that is used (sans reaction solvents) is considered as the fluidity of the active.

Side products as discussed above can provide advantages in some situations. For instance, mono-tail side products can be useful for complexing residual anionic surfactant, a material that is often carried over into the rinse from the detergent used in the wash cycle. In this way, the mono-tail material acts as a sacrificial material to protect the di-tail materials, that provide higher fabric care performance, from being precipitated in the rinse by complexation with residual anionic surfactant. Some side products may also be useful for adjusting the fluidity of the mixture.

Hydrophobic Quaternary Ammonium Compounds

Hydrophobic Quaternary Ammonium Compounds Comprising Hydrophobes with Chain Interrupters

Preferred PFSA and FSCA are hydrophobic quateranary ammonium compounds having chain interrupters (which are designated “Y” herein below). In more preferred structures, the chain interrupters is capable of hydrolytic cleavage. The proclivity for hydrolytic cleavage is especially preferred when the PFSA or FSCA are used in applications requiring biodegradeably species. Several general structures for hydrophobic quaternary ammonium compounds wherein the hydrophobes have chain interrupters are detailed below:
{R₄₋ₘ—N⁺—[(CH₂)ₙ—Y—R¹]ₘ}X⁻ i.
wherein each R substituent is either hydrogen, a small hydrocarbon or substituted hydrocabon comprising one to about six carbons with some nonlimiting examples including., methyl, ethyl, propyl, hydroxyethyl, and the like, poly (C₂₋₃ alkoxy), benzyl, or mixtures thereof; each m is 2 or 3; each n is from 1 to about 4, preferably 2; each Y is a hydrocarbon chain interrupter, including, but not limited to —O—, —N—, —O—(O)C—, —C(O)—O—, —NR—C(O)—, or —C(O)—NR—; each Y can be the same or different the sum of carbons in each R¹, plus one when Y contains one carbon, is about C₁₂ to about C₂₂, preferably about C₁₄ to about C₂₀, with each R¹ being a hydrocarbyl, or substituted hydrocarbyl group, it is acceptable for R¹ to be saturated, unsaturated, branched, linear, cyclic, or combinations thereof, each R¹ can be the same or different
[R₃N⁺CH₂CH(YR¹)(CH₂YR¹)]X⁻ ii.
wherein each Y, R, and R¹ have the same meanings as before. Such compounds include those having the formula:
[CH₃]₃ N⁽⁺⁾[CH₂CH(CH₂O(O)CR¹)O(O)CR¹]Cl⁽⁻⁾
wherein each R is a methyl or ethyl group and preferably each R¹ is in the range of about C₁₁ to about C₂₁. As used herein, when the diester is specified, it can include the monoester that is present.

A preferred embodiment of the hydrophobic quaternary ammonium compound is one in which Y is an ester linkage. Such compounds can be prepared by standard reaction chemistry utilizing fatty acids and amino alcohols followed by quaternization with alkylating agents or pH adjustment.

These types of agents and general methods of making them are disclosed in U.S. Pat. No. 4,137,180, Naik et al., issued Jan. 30, 1979, which is incorporated herein by reference.

Hydrophobic quaternary ammonium compounds with ester linkages herein can also contain a low level of fatty acid, which can be from unreacted starting material used to form the ammonium ester and/or as a by-product of any partial degradation (hydrolysis) of the softener active in the finished composition. It is preferred that the level of free fatty acid be low, preferably below about 15%, more preferably below about 10%, and even more preferably below about 5%, by weight of the softener active.

Hydrophobic Quaternarv Ammonium Compounds without Chain Interrupters

Hydrophobic quaternary ammonium compounds without chain interrupters are also acceptable, but less prefferred especially where hydrolytic degradation of the active is desired for purposes such as biodegradability. Such materials have the following general formula:
[R₄₋ₘ—N⁽⁺⁾—R¹ₘ] A⁻
wherein each m is 2 or 3, each R¹ is a C₆-C₂₂, preferably C₁₄-C₂₀, wherein each R¹ is the same or different and it is acceptable for R¹ to be linear, branched, cyclic, acyclic, saturated, and/or unsaturated.
Cyclic Amine or Ammonium Compounds

While materials with cyclic amine or ammonium compounds are acceptable as PFSA and FSCA, thes are generally preferred for use as FSCA. A variety of general formulas for compound with cyclic amine or ammonium compounds are disclosed below.

Imidazolinium Compounds 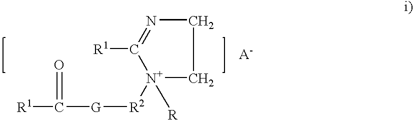
wherein each R, R¹, and A⁻ have the definitions given above; each R² is a C₁₋₆ alkylene group, preferably an ethylene group; and G is equivalent to Y disclosed above; and: 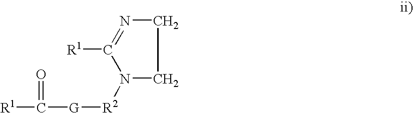
wherein R¹, R² and G are defined as above; and: 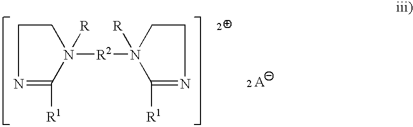
wherein R, R¹, R², and A⁻ are defined as above; and

iv) substituted imidazolinium salts having the formula: 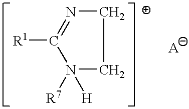
wherein R⁷ is hydrogen or a C₁-C₄ saturated alkyl or hydroxyalkyl group, and R¹ and A⁻ are defined as hereinabove;

v) substituted imidazolinium salts having the formula: 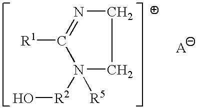
wherein R⁵ is a C₁-C₄ alkyl or hydroxyalkyl group, and R¹, R², and A⁻ are as defined above;

2) alkylpyridinium salts having the general formulas disclosed below: 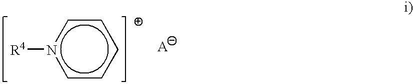
wherein R4 is an acyclic aliphatic C₈-C₂₂ hydrocarbon group and A⁻ is an anion; and

ii) alkanamide alkylene pyridinium salts having the formula: 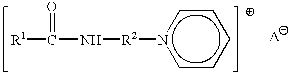
wherein R¹, R² and A⁻ are defined as herein above; and mixtures thereof.

Additional fabric softeners that can be used herein are disclosed, at least generically for the basic structures, in U.S. Pat. No. 3,861,870, Edwards and Diehl; U.S. Pat. No. 4,308,151, Cambre; U.S. Pat. No. 3,886,075, Bernardino; U.S. Pat. No. 4,233,164, Davis; U.S. Pat. No. 4,401,578, Verbruggen; U.S. Pat. No. 3,974,076, Wiersema and Rieke; and U.S. Pat. No. 4,237,016, Rudkin, Clint, and Young. The additional softener actives herein are preferably those that are highly unsaturated versions of the traditional softener actives, i.e., di-long chain alkyl nitrogen derivatives, normally cationic materials, such as dioleyldimethylammonium chloride and imidazolinium compounds as described hereinafter. Examples of more biodegradable fabric softeners can be found in U.S. Pat. No. 3,408,361, Mannheimer, issued Oct. 29, 1968; U.S. Pat. No. 4,709,045, Kubo et al., issued Nov. 24, 1987; U.S. Pat. No. 4,233,451, Pracht et al., issued Nov. 11, 1980; U.S. Pat. No. 4,127,489, Pracht et al., issued Nov. 28, 1979; U.S. Pat. No. 3,689,424, Berg et al., issued Sept. 5, 1972; U.S. Pat. No. 4,128,485, Baumann et al., issued Dec. 5, 1978; U.S. Pat. No. 4,161,604, Elster et al., issued July 17, 1979; U.S. Pat. No. 4,189,593, Wechsler et al., issued Feb. 19, 1980; and U.S. Pat. No. 4,339,391, Hoffman et al., issued July 13, 1982.

Polyhydroxy Materials and Sugar Derivatives

Polyhydroxy amide structures as disclosed in U.S. Pat. No. 5,534,197 by Scheibel et al. and U.S. Pat. No. 5,512, 699 by Connor et al. are suitable materials for PFSA's or FSCA's and are disclosed herein by reference.

Pentaerythritol compounds and derivatives as disclosed in U.S. Pat. No. 6,294,516 are suitable materials for PFSA's or FSCA's and are disclosed herein by reference.

Cyclic polyols and/or reduced saccharides as disclosed in WO 01/07546 Al are suitable materials for PFSA's or FSCA's and are disclosed herein by reference.

Polyguaternary Ammonium Compounds

The following polyquaternary ammonium compounds are disclosed by reference herein as suitable for use in this invention:

(4) reaction products of substantially unsaturated and/or branched chain higher fatty acids with dialkylenetriamines in, e.g., a molecular ratio of about 2:1, said reaction products containing compounds of the formula:
R¹—C(O)—NH—R²—NH—R³—NH—C(O)—R¹
wherein R1, R2 are defined as above, and each R3 is a C1-6 alkylene group, preferably an ethylene group;

(5) softener having the formula:
[R¹—C(O)—NR—R²—N(R)₂—R³—NR—C(O)—R¹]⁺ A⁻
wherein R, R1, R2, R3 and A⁻ are defined as above;

(6) the reaction product of substantially unsaturated and/or branched chain higher fatty acid with hydroxyalkylalkylenediamines in a molecular ratio of about 2:1, said reaction products containing compounds of the formula:
R¹—C(O)—NH—R²—N(R³OH)—C(O)—R¹
wherein R1, R2 and R3 are defined as above.

European Patent Application EP 0,803,498, A1, Robert O. Keys and Floyd E. Friedli, filed Apr. 25, 1997; British Pat. 808,265, issued Jan. 28, 1956 to Arnold Hoffman & Co., Incorporated; British Pat. 1,161,552, Koebner and Potts, issued Aug. 13, 1969; DE 4,203,489 A1, Henkel, published Aug. 12, 1993; EP 0,221,855, Topfl, Heinz, and Jorg, issued Nov. 3, 1986; EP 0,503,155, Rewo, issued Dec. 20, 1991; EP 0,507,003, Rewo, issued Dec. 20, 1991; EPA 0,803,498, published Oct. 29, 1997; French Pat. 2,523,606, Marie-Helene Fraikin, Alan Dillarstone, and Marc Couterau, filed Mar. 22, 1983; Japanese Pat. 84-273918, Terumi Kawai and Hiroshi Kitamura, 1986; Japanese Pat. 2-011,545, issued to Kao Corp., Jan. 16, 1990; U.S. Pat. No. 3,079,436, Hwa, issued Feb. 26, 1963; U.S. Pat. No. 4,418,054, Green et al., issued Nov. 29, 1983; U.S. Pat. No. 4,721,512, Topfl, Abel, and Binz, issued Jan. 26, 1988; U.S. Pat. No. 4,728,337, Abel, Topfl, and Riehen, issued Mar. 1, 1988; U.S. Pat. No. 4,906,413, Topfl and Binz, issued Mar. 6, 1990; U.S. Pat. No. 5,194,667, Oxenrider et al., issued Mar. 16, 1993; U.S. Pat. No. 5,235,082, Hill and Snow, issued Aug. 10, 1993; U.S. Pat. No. 5,670,472, Keys, issued Sep. 23, 1997; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4th Edition, published 1991 by Lea & Febiger, Chapter 13, pp. 226-30. All of these references are incorporated herein, in their entirety, by reference. The products formed by quaternization of reaction products of fatty acid with N,N,N′,N′, tetraakis(hydroxyethyl)-1,6-diaminohexane are also disclosed as suitable for this invention. Some nonlimiting structural examples produced by this reaction are given below: 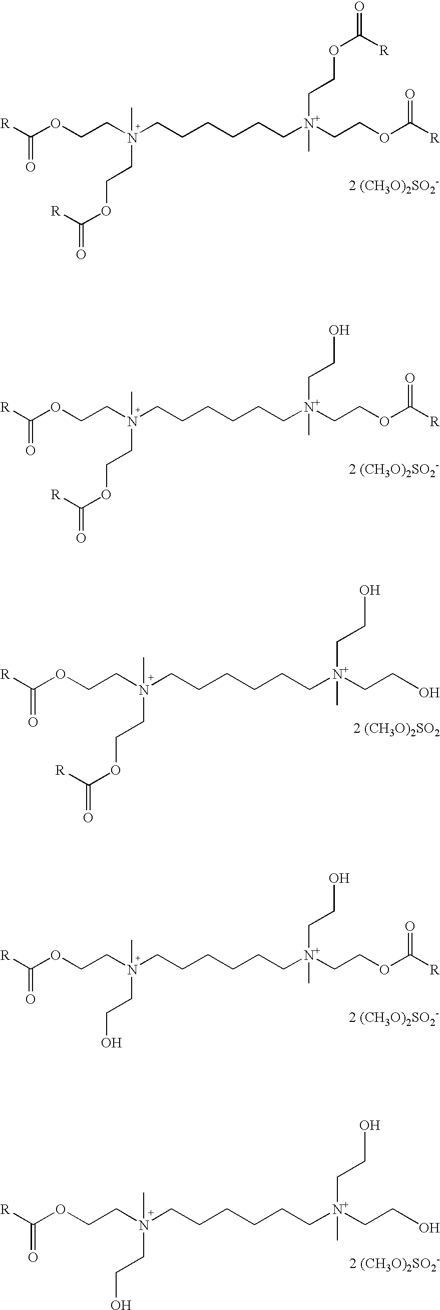 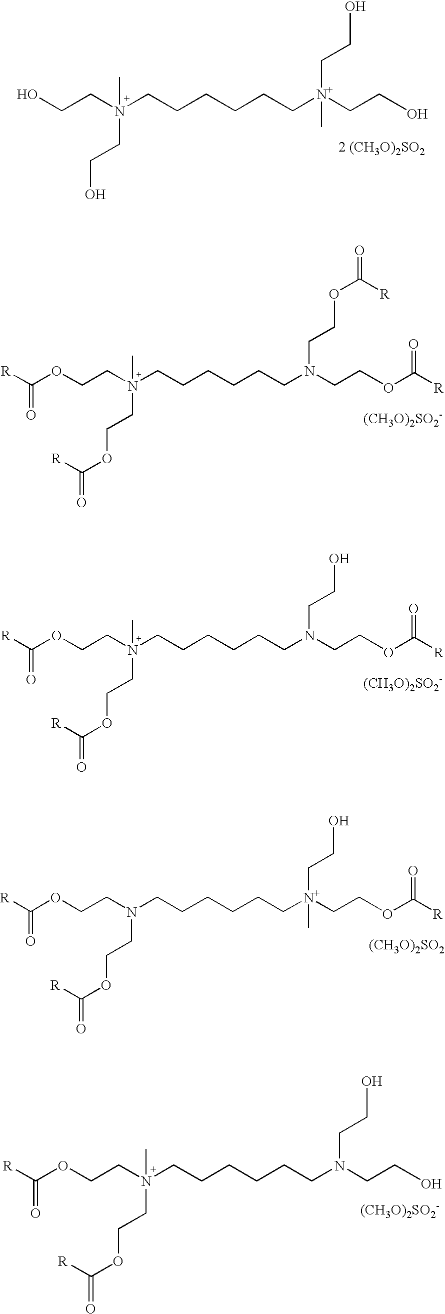 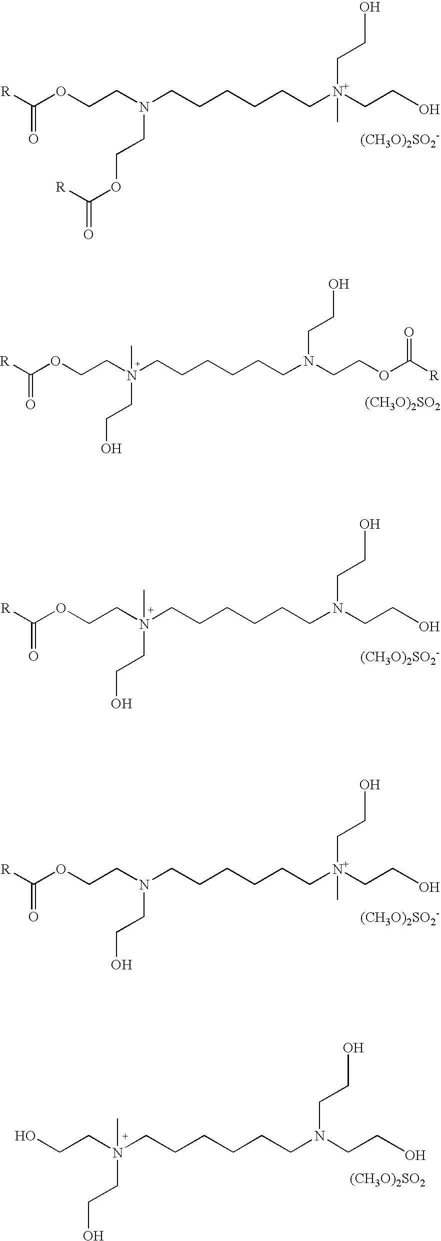 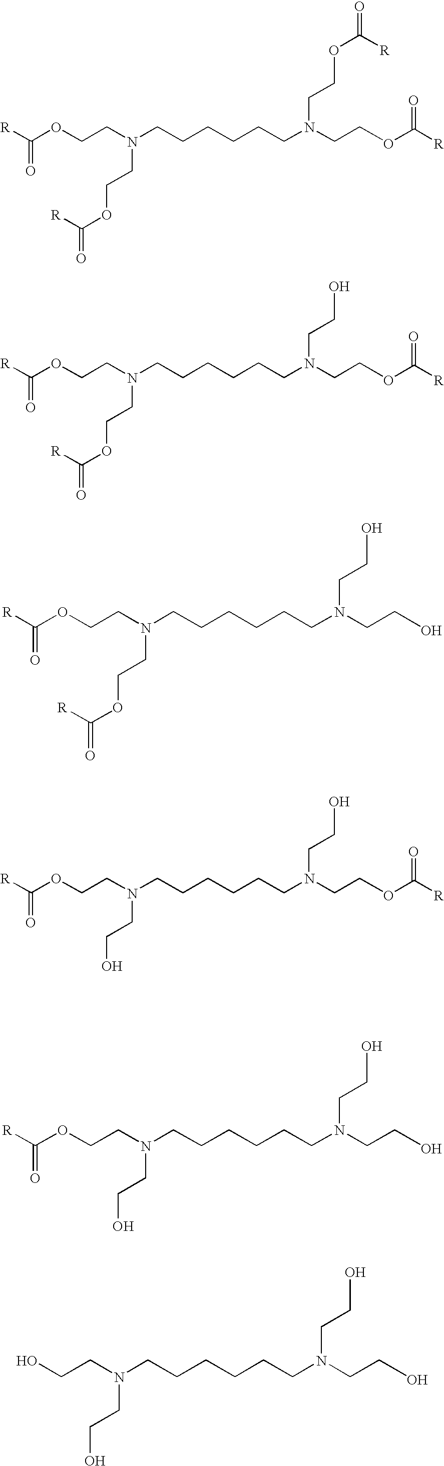
and R is defined as R1 as described above.

For softening via such types of fabric softening actives, under no/low detergent carry-over laundry conditions the percentage of monoester should be as low as possible, preferably no more than about 15%. However, under high, anionic detergent surfactant or detergent builder carry-over conditions, some monoester can be preferred. The overall ratios of diester “quaternary ammonium active” (quat) to monoester quat are from about 2.5:1 to about 1:1, preferably from about 2.3:1 to about 1.3:1. Under high detergent carry-over conditions, the di/monoester ratio is preferably about 1.3:1. The level of monoester present can be controlled in manufacturing the DEQA by varying the ratio of fatty acid, or fatty acyl source, to triethanolamine. The overall ratios of diester quat to triester quat are from about 10:1 to about 1.5: 1, preferably from about 5:1 to about 2.8:1.

When high unsaturation is present fabric softener actives herein are preferably prepared by a process wherein a chelant, preferably a diethylenetriarninepentaacetate (DTPA) and/or an ethylene diamine-N,N′-disuccinate (EDDS) is added to the process. Another acceptable chelant is tetrakis-(2-hydroxylpropyl) ethylenediamine (TPED). Also, preferably, antioxidants are added to the fatty acid immediately after distillation and/or fractionation and/or during the esterification reactions and/or post-added to the finished softener active. The resulting softener active has reduced discoloration and malodor associated therewith.

The total amount of added chelating agent is preferably within the range of from about 10 ppm to about 5,000 ppm, more preferably within the range of from about 100 ppm to about 2500 ppm by weight of the formed softener active.

The above processes produces a fabric softener active with reduced coloration and malodor.

### Anions Designated by X and A

In the cationic nitrogenous salts herein, the anion which is designated both X— and A⁻ herein, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

It will be understood that all combinations of softener structures disclosed above are suitable for use in this invention.

The fabric softening active systems for incorporation in the present composition are preferably free of TEA ester fabric softening actives as described in U.S. Pat. No. 4,963,274 at col. 2, lines 1-20. Although these TEA ester fabric softening actives can be utilized in the mixed fabric softening active systems of the present composition, they are not preferred.

Preferably, the mixed fabric softening active system of the present compositions comprises at least two diester fabric softening actives, as described hereinbefore.

Other highly suitable fabric softening actives for use in the mixed fabric softening active system of the present compositions include the highly-fluid fabric softening actives comprising certain ratios of mono-tail and di-tail groups as described in co-pending U.S. Provisional Application Ser. No. 60/388,324 filed Jun. 13, 2002 by G. Frankenbach (Case 8973P).

The mixed fabric softening active system of the present compositions can be made in a variety of ways. It can be made by simply combining together at least two of the cationic fabric softening actives described above that are readily available commercially.

A suitable process for making the present compositions is described as follows. The PFSA and the FSCA are melted together and intimately mixed. When forming the initial mixture of actives, these actives can be mixed by conventional means, e.g. stirring by hand, with a stir bar, or low shear blade assembly. However, it is preferable to the PFSA and CFSA mixture by high shear methods to guarentee a homogeneous combination of actives prior to forming the dispersion in water. Typically the mixed-active system is then combined with water to form a dispersion using high shear processing techniques. This intimate mixture of PFSA and FSCA is preferably pumped into a “water seat” containing an acid (when optional agents for pH adjustment are used) and subjected to high shear. At this point, a gelatinous composition typically forms. When optional salt is used, a dilute salt mixture is injected into gelatinous composition to lower the viscosity of the composition. The mixture is again subjected to high shear. Any optional stability polymers can be added at this point followed by optional perfume addition. After the optional perfume addition, if optional salt is used, a higher dose of salt solution is added at this point.

An alternative process for making the mixed fabric softening active system of the present compositions is described as follows. This process for manufacturing cationic softener actives of this invention is to pre-blend fatty acids or fatty oil feedstocks before beginning the reaction process with the appropriate amine or mixture of amines. For example, preferred biodegradable diester and monoester quaternary softener actives of this invention based on the reaction product of fatty acids and methyldiethanolamine can be prepared as follows:

1. Mix partially hardened tallow fatty acid with an IV of about 56 with partially hardened canola fatty acid (or oleic acid) with an IV of about 93. The ratio of tallow fatty acid to canola fatty acid (or oleic acid) is preferably from about 1:5 to about 5:1, more preferably from about 3:1 to about 1:1.

2. React mixture with methyldiethanolamine to form the di- and monoester amine intermediates.

3. React intermediates with a quaternizing agent, preferably methyl chloride or dimethyl sulfate.

4. Solvents such as ethanol, isopropanol, hexylene glycol, and additional fatty acids can be added before, during or after the quaternization reaction to aid in processability and fluidity.

Alternatively, tallow or canola oil can be used as feedstocks and pre-blended together before reaction. A preferred alternative amine feedstock is triethanolamine, and in this case, the preferred quaternization solvent is dimethyl sulfate.

Liquid Carrier

The compositions of the present invention herein comprise from about 60% to about 90%, preferably from about 65% to about 85% of an aqueous liquid carrier. The preferred aqueous carrier is water which can contain minor ingredients.

Optional Ingredients

The following optional ingredients are useful for improving the performance and/or physical properties of the present invention, agents for pH adjustment, perfume, solvent, salt, monotail amphiphilic compounds, polymers, chelants, color care agents, wrinkle control agents, silicone compound, soil release agent, presevatives, viscosity aids, and the like.

1. Agents for pH Adjustment

Typically, compositions of the present invention have a pH between about 1.5 and 12. Agents for pH adjustment are optional ingredients, but when the composition comprises compounds susceptible to hydrolysis, agents for pH adjustment are highly preferred optional ingredients for adjusting the pH into a range where hydrolytic degredation of the susceptible compounds, particular susceptible fabric softening agents, such as those comprising ester linkages, is significantly reduced. pH ranges for making stable softener compositions containing diester quaternary ammonium fabric softening compounds are disclosed in U.S. Pat. No. 4,767,547, Straathof, issued Aug. 30, 1988, which is incorporated herein by reference.

Fully-formulated fabric softening compositions made by the process of the present invention can optionally contain mineral or organic acids, e.g. HCl, H2SO4, succinic acid, or bases such as ammonium chloride.

2. Perfume

Aesthetic benefits derived from perfumery are highly valued to users of compositions of the present invention. Therefore, perfumes, while optional are highly preferred optional ingredients. The present invention can contain any softener compatible perfume or fragrance ingredient. A non-limiting selection of suitable, but preferred, perfumes are disclosed in U.S. Pat. No. 5,500,138 and U.S. Pat. No. 5,652,206 said patents being incorporated herein by reference. Perfume can be present at a level of from 0% to 10%. Compositions typically include less than about 3.0%; preferably, less than about 2.0% more preferably less than 1.6%, and typically greater than about 0.5% perfume.

As used herein, perfume includes fragrant substance or mixture of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. Such materials are often accompanied by auxiliary materials, such as fixatives, extenders, stabilizers and solvents. These auxiliaries are also included within the meaning of “perfume”, as used herein. Typically, perfumes are complex mixtures of a plurality of organic compounds.

Examples of perfume ingredients useful in the perfumes of the present invention compositions include, but are not limited to, hexyl cinnamic aldehyde; amyl cinnamic aldehyde; amyl salicylate; hexyl salicylate; terpineol; 3,7-dimethyl-cis-2,6-octadien-1-ol; 2,6-dimethyl-2-octanol; 2,6-dimethyl-7-octen-2-ol; 3,7-dimethyl-3-octanol; 3,7-dimethyl-trans-2,6-octadien-1-ol; 3,7-dimethyl-6-octen-1-ol; 3,7-dimethyl-1-octanol; 2-methyl-3-(para-tert-butylphenyl)-propionaldehyde; 4-(4-hydroxy-4-methylpentyl)-3-cyclohexene-1-carboxaldehyde; tricyclodecenyl propionate; tricyclodecenyl acetate; anisaldehyde; 2-methyl-2-(para-iso-propylphenyl)-propionaldehyde; ethyl-3-methyl-3-phenyl glycidate; 4-(para-hydroxyphenyl)-butan-2-one; 1-(2,6,6-trimethyl-2-cyclohexen-1-yl)-2-buten-1-one; para-methoxyacetophenone; para-methoxy-alpha-phenylpropene; methyl-2-n-hexyl-3-oxo-cyclopentane carboxylate; undecalactone gamma.

Additional examples of fragrance materials include, but are not limited to, orange oil; lemon oil; grapefruit oil; bergamot oil; clove oil; dodecalactone gamma; methyl-2-(2-pentyl-3-oxo-cyclopentyl) acetate; beta-naphthol methylether; methyl-beta-naphthylketone; coumarin; decylaldehyde; benzaldehyde; 4-tert-butylcyclohexyl acetate; alpha,alpha-dimethylphenethyl acetate; methylphenylcarbinyl acetate; Schiff's base of 4-(4-hydroxy-4-methylpentyl)-3-cyclohexene-1-carboxaldehyde and methyl anthranilate; cyclic ethyleneglycol diester of tridecandioic acid; 3,7-dimethyl-2,6-octadiene-1-nitrile; ionone gamma methyl; ionone alpha; ionone beta; petitgrain; methyl cedrylone; 7-acetyl-1,2,3,4,5,6,7,8-octahydro-1,1,6,7-tetramethyl-naphthalene; ionone methyl; methyl-1,6,10-trimethyl-2,5,9-cyclododecatrien-1-yl ketone; 7-acetyl-1,1,3,4,4,6-hexamethyl tetralin; 4-acetyl-6-tert-butyl-1,1-dimethyl indane; benzophenone; 6-acetyl-1,1,2,3,3,5-hexamethyl indane; 5-acetyl-3-isopropyl-1,1,2,6-tetramethyl indane; 1-dodecanal; 7-hydroxy-3,7-dimethyl octanal; 10-undecen-1-al; iso-hexenyl cyclohexyl carboxaldehyde; formyl tricyclodecan; cyclopentadecanolide; 16-hydroxy-9-hexadecenoic acid lactone; 1,3,4,6,7,8-hexahydro-4,6,6,7,8,8-hexamethylcyclopenta-gamma-2-benzopyrane; ambroxane; dodecahydro-3a,6,6,9a-tetramethylnaphtho-[2,1b]furan; cedrol; 5-(2,2,3-trimethylcyclopent-3-enyl)-3-methylpentan-2-ol; 2-ethyl-4-(2,2,3-trimethyl-3-cyclopenten-1-yl)-2-buten-1-ol; caryophyllene alcohol; cedryl acetate; para-tert-butylcyclohexyl acetate; patchouli; olibanum resinoid; labdanum; vetivert; copaiba balsam; fir balsam; and condensation products of: hydroxycitronellal and methyl anthranilate; hydroxycitronellal and indol; phenyl acetaldehyde and indol; 4-(4-hydroxy-4-methyl pentyl)-3-cyclohexene-1-carboxaldehyde and methyl anthranilate.

More examples of perfume components are geraniol; geranyl acetate; linalool; linalyl acetate; tetrahydrolinalool; citronellol; citronellyl acetate; dihydromyrcenol; dihydromyrcenyl acetate; tetrahydromyrcenol; terpinyl acetate; nopol; nopyl acetate; 2-phenylethanol; 2-phenylethyl acetate; benzyl alcohol; benzyl acetate; benzyl salicylate; benzyl benzoate; styrallyl acetate; dimethylbenzylcarbinol; trichloromethylphenylcarbinyl methylphenylcarbinyl acetate; isononyl acetate; vetiveryl acetate; vetiverol; 2-methyl-3-(p-tert-butylphenyl)-propanal; 2-methyl-3-(p-isopropylphenyl)-propanal; 3-(p-tert-butylphenyl)-propanal; 4-(4-methyl-3-pentenyl)-3-cyclohexenecarbaldehyde; 4-acetoxy-3-pentyltetrahydropyran; methyl dihydrojasmonate; 2-n-heptylcyclopentanone; 3-methyl-2-pentyl-cyclopentanone; n-decanal; n-dodecanal; 9-decenol-1; phenoxyethyl isobutyrate; phenylacetaldehyde dimethylacetal; phenylacetaldehyde diethylacetal; geranonitrile; citronellonitrile; cedryl acetal; 3-isocamphylcyclohexanol; cedryl methylether; isolongifolanone; aubepine nitrile; aubepine; heliotropine; eugenol; vanillin; diphenyl oxide; hydroxycitronellal ionones; methyl ionones; isomethyl ionomes; irones; cis-3-hexenol and esters thereof; indane musk fragrances; tetralin musk fragrances; isochroman musk fragrances; macrocyclic ketones; macrolactone musk fragrances; ethylene brassylate.

Suitable solvents, diluents or carriers for perfumes ingredients mentioned above are for examples, ethanol, isopropanol, diethylene glycol, monoethyl ether, dipropylene glycol, diethyl phthalate, triethyl citrate, etc. The amount of such solvents, diluents or carriers incorporated in the perfumes is preferably kept to the minimum needed to provide a homogeneous perfume solution.

Perfume ingredients may also be suitably added as releasable fragrances, for example, as pro-perfumes or pro-fragrances as described in U.S. Pat. No. 5,652,205 Hartman et al., issued Jul. 29, 1997 incorporated herein by reference.

Perfume is a highly desirable optional due to the ability of perfume to strongly improve consumer acceptance of compositons disclosed herein.

3. Solvents & Solvatropes

Solvents and solvatropes both those that are water-miscible and water immiscible, can be useful for imparting stability improvements to compositions disclosed herein, together with stability improvements imparted due to mixing of appropriate PFSA and FSCA. Additionally, solvents and solvatropes can be helpful in improving the dispersibility of concentrated compositions. Some preferred, but non-limiting solvents and solvatropes include materials comprising about 2 to about 12 carbons and 1 to about 6 oxygens such as ethanol, isopropanol, hexylene glycol, 1,2-hexanediol, propylene glycol, 2,22,4-trimethyl-1,3-pentanediol, 2-ehtylhexyl-1,3-diol. Additional suitable solvent and solvatrope materials include compounds with a Clog P from about −2 to about 2.6 as disclosed in U.S. application Ser. Nos. 09/308,128 filed May 10, 1999, and 09/554,969 filed May 23, 2000 by Frankenbach et al.

4. Salts & Hydrotropes

Salts and hydrotropes, can be useful for imparting stability improvements to compositions disclosed herein, together with stability improvements imparted due to mixing of appropriate PFSA and FSCA. Additionally, salts and hydrotropes can be helpful in improving the dispersibility of concentrated compositions. Some preferred, but non-limiting salts include halids of the group IA and II A metals on the the periodic chart such as NaCl, CaCl₂, and MgCl₂. Organic salts are also useful for the compositions further improving the stability of compositions disclosed herein. Some nonlimiting examples of hydrotropes are sodium cumeme sulfonate, sodium xylene sulfonate, calcium cumene sulfonate, calcium xylene sulfonate. A more comprehensive list of useful salts and hydrotropes is described in U.S. application Ser. No. 09/308,128 filed May 10, 1999, and Ser. No. 09/554,969 filed May 23, 2000 by Frankenbach et al.

5. Mono-Tail Amphiphilic Compounds:

It is often desireable to add an optional mono-tail amphiphilic compound to improve a variety of performance attributes including but not limited to improved softening performance, improved wrinkle control performance, and improved dispersibility. In general, these are materials having a hydrocarbyl chain with equal to or greater than about six carbons. Such materials can be nonionic cationic or zwitterionic, or anionic. When monotail materials are used to provided benefit improvements, the materials are included at levels of from about 0.5% to about 10%, and preferably from about 1% to about 5%. Materials which provide benefits as dispersibility aids are disclosed in U.S. application Ser. Nos. 09/622,968 filed Mar. 2, 1999 by Duval et al. and in U.S. Pat. No. 5,545,340 issued Aug. 13, 1996 to Wahl et al.

Other optional but highly desirable cationic compounds which can be used in combination with the above softener actives are compounds containing one long chain acyclic C₈-C₂₂ hydrocarbon group, selected from the group consisting of:
[R¹—N(R⁵)₃]⁺ A⁻
R¹ is hydrocarbon group having about 6 to about 22 carbons that is preferably, but not necessarily linear. R⁵is a hydrogen or a hydrocarbon having less than about 10 carbons. Each R⁵ can be the same or different.
6. Cationic Polymers

Cationic Polymers are useful for boosting performance benefits such as softening, wrinkle control, and color care. Not to be bound by theory, but it is believed that cationic polymers function via a variety of mechanisms. Cationic polymers can scavenge residual anionic surfactants carried over into the rinse from laundry detergent used in the wash cycle. In this way, the cationic polymer protects the fabric softener active from complexing with the anionic surfactant which would reduce the efficacy of the active. Cationic polymers can also smooth out fibers by pasting down fibrils and the resulting reduced potential for physical entanglement and friction between fibers contributes to improving wrinkle control performance.

Composition herein can contain from about 0.001% to about 10%; preferably from about 0.01% to about 5%′ more preferably from about 0.1% to about 2% of cationic polymer, typically having a molecular weight of from about 500 to about 10,000,000; preferably from about 1,000 to bout 250,000 and a charge density of at least about 0.01 meq/g preferably from about 0.01 meq/g to about 8 meq/g.

The cationic polymers of the present invention can be amin salts or quaternary ammonium salts. They include cationic derivatives of natural polymers such as some polysaccharide gums, starch, and certain cationic synthetic polymers and co-polymers of cationic vinyl pyridine or vinyl pyridinium halides. Preferably the polymers are water soluble for instanc to the extent of at least 0.5% by weight at 20 C.

Suitable dersirable cationic polymers are disclosed in CTFA International Cosmetic Ingredient Dictionary, 4th Ed., J. M. Nikitakis, et al., Editors, published by the Cosmetic, Toiletry, and Fragran Association, 1991, incorporated herein by reference. Also, suitable cationic polymers and polyethyleneimines are disclosed in the following references included herein by reference, U.S. Pat. No. 5,977,055, Trinh et al. issued Nov. 02, 1999, U.S. Pat. No. 2,182,306, Ulrich et al. issued Dec. 5, 1939, U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep 17, 1957; U.S. Pat. No. 2,553,696, Wilson, issued May 21, 1951.

7. Color Care Agents

There are a variety of materials that can provide color care improvements in the context of the present compositions. These include chlorine protection agents, dye transfer inhibitors, dye fixatives, and chelants.

a) Chlorine Protection Agents

Chlorine protection agents are materials that react with or nuetralize the bleaching efficacy of chlorine or with chlorine generating materials like hypochlorite to eliminate or the bleaching activity of chlorine generating materials. An effective amount of chlorine scavenger can be selected from the following non-limiting groups: 1) amines and their salts, 2) ammonium salts, 3) amino acids and their salts, 3) polyamino acids and their salts, 4) polyehtyleneimines and their salts, 5) polyamines and their salts, 6) polyamineamides and their salts, 7) polyacrylamides and their salts, 8) and combinations thereof. For use in rinse-added compositions of the present invention it is suitable to incorporate enough chlorine scavenger to scavenge about 1 ppm of chlorine, preferably 2 ppm, more preferably 3 pm, and most preferably 10 ppm of chlorine in the rinse. The structure, use, and incorporation of chlorine protection agents useful in fabric care compositions are disclosed in more detail in U.S. Pat. Nos. 5,977,055, 6,046,155 both by T. Trinh et al, and U.S. Pat. No. 6,107,270 by J. W. Smith et al. and this information is included herein by reference.

b) Dye Transfer Inhibitors (DTI)

Dye transfer inhibitors are materials that prevent fugitive dyes in the rinse liquor from redepositing on fabrics. Fugitive dyes are dye molecules or aggregates that have left fabric they were associated with prior to the wash process and then entered the wash and/or rinse baths. DTI's appear to function by solubilzing in water, binding with fugitive dyes and thus preventing the fugitive dyes from redepositing on fabric. Redeposition of fugitive dyes corrupts the orginal color of a fabric leading to loss of color fidelity over time. DTI's are typically, but not necessarily polymeric materials. Preferably, the DTI is a water soluble polymer comprising oxygen or nitrogen atoms selected from the group consisting of 1) polymers which are preferably not enzymes, with one or more monomeric units containing at least one ═N—C(=0) group; 2) polymers with one or more monomeric units containing at least one N-oxide group; 3) polymers containing both ═N—C(═O) and N-oxide groups; and 4) mixtures thereof; wherein the nitrogen of the ═N—C(═O) can be bond to one or two other atoms (i.e. can have two single bonds or one double bond). Polyvinyl pyrrolidone is a typical, but nonlimiting examples of such structures., ne effective amount of DTI in the present composition, is an amount that releases at least about 0.1 ppm in the rinse liquor, preferably about 0.1 ppm to about 100 ppm, more preferably about 0.2 ppm to about 20 ppm is released in the rinse liquor. Suitable structures, use and incorporation of DTI's in fabric care compositions are disclosed in further detail in the following patents WO 94/11482 published 26 May 1994 and U.S. Pat. No. 5,977,055 by T. Trinh et al. granted 2 Nov. 1999.

c) Dye Fixatives

Dye fixatives are similar to dye transfer inhibitors, but tend to be more water insoluble. They act primarily by inhibiting removal of the dye rather than intercepting it in the water phase and keeping it suspended like the DTI's. Dye fixatives that are suitable for the present invention are disclosed in U.S. Pat. No. 5,632,781, Shinichie et al. granted 27 May 1997, U.S. Pat. No. 4,583,989 Toshino et al. issued 22 April 1986; U.S. Pat. No. 3,957,574 Edward granted 18 May 1975; U.S. Pat. No. 3,957,427 Chambers issued 18 May 1976; U.S. Pat. No. 3,940,247 Derwin et al. granted 24 Feb. 1976, all of the said patents being incorporated by reference.

The dye fixatives are used in at least an effective amount, typically from about 0.01% to about 10%, preferably from about 0.03% to about 7%, more preferably from about 0.1% to about 3%.

d) Chelants

Chelants are also suitable materials for imparting improved color protection in the present invention. Chelants are typically effective by binding metals in solution or precipitating metals out of solutions.

Polyamine compounds particularly those with the structure below are preferred materials to impart color care through chelating action:
(R¹)₂N(CX₂)ₙN(R²)₂
wherein each X is preferably hydrogen but other suitable structures for X include linear or branched alkyl groups that are substituted or unsubstituted comprising 1 to about 10 carbons, but preferably 1 to 2 carbons; aryl groups with at least about 5 carbons and preferably from 5 to about 22 carbons, and mixtures thereof; n is an interger from 0 to about 6 preferably from 2 to about 3; each R¹ and R² is independently selected from the group consisting of hydrogen, alkyl, aryl, akylaryl, hydroxyalkyl, polyhydroxyalkyl, C₁₋₁₀, preferably C₂₋₃, alkyl groups substituted with preferably 1 or suitably more carboxylic acid or phosphonic acid groups or salts; and when substituted with more than one acid or salt, the substitution number is preferably 2 or 3; polyalkyether having the structure —((CH2)yO)z-R3, where each R3 is preferably hydrogen or suitably a linear or branched, substituted or unsubstituted alkyl group having from about 1 to about 10 carbons, preferably from about 1 to about 4 carbon atoms and where y is an interger from about 2 to about 10, preferably from about 2 to about 3 and z is an interger from about 1 to abou 30, preferably from about 2 to about 5; R3 can also suitably include —C(O)R4 where each R⁴ is selected from the group consisting of alkyl, aryl, alkylaryl, hydroxyalkyl polyhydroxyalkyl polyalkylether and alkyl groups substituted with most preferably one, but suitably more (preferably 2 or 3) carboxylic acid and phosphonic acid groups or salts, —CX₂CX₂N(R⁵) with no more than one of R¹ or R² being —CX₂CX₂N(R⁵) and is selected from the group consisting of is selected from the group consisting of alkyl, aryl, alkylaryl, hydroxyalkyl polyhydroxyalkyl polyalkylether and alkyl groups substituted with most preferably one, but suitably more (preferably 2 or 3) carboxylic acid and phosphonic acid groups or salts as defined in R¹ or R², and one R¹ and one R² can combine to form a cyclic compound.

A variety of other polyanionic groups are suitable as chelating agents including, but not limited to citric acid, citrate salts, isoporpyl citrate, 1-hydroxyethylidene-1,1-diphosphonic acid available as Dequest RTM 20110 from Monsanto, 4,5-dihydroxy-m-benzenesulfonic acid/sodium salt available from Kodak as Tiron RTM, diethylenetriaminepentaacidic acid available from Aldrich, ethylenediaminetetraacetic acid (EDTA), ethylenediamine-N,N′-disuccinic acid (EDDS preferably the S,S isomer) 8-hydroxyquinoline, sodium dithiocarbamate, sodium tetraphenyl boron, ammonium nitrosophenyl hydroxylamine, and mixtures thereof. Chelants, when used, are included at levels of from about 0.01% to about 10% preferably from about 0.1% to about 8%, and most preferably from about 0.5% to about 5%. The structures, use, and incorporation of chelants in fabric care compositions for imparting color care are disclosed in more detail in the following U.S. Pat. No.5,977,055 by T.Trinh et al. and U.S. Pat. No. 5,686,376 issued Nov. 11, 1997 to J. Rusche et al.

8. Enzymes

The compositions and processes herein can optionally comprise one or more enzymes such as lipases, proteases, cellulase, amylases and peroxidases. A preferred enzyme for use herein is a cellulase enzyme. Indeed, this type of enzyme will further provide a color care benefit to the treated fabric. Cellulases usable herein include both bacterial and fungal types, preferably having a pH optimum between 5 and 9.5. U.S. Pat. No. 4,435,307 discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A-2.095.275 and DE-OS-2.247.832. CAREZYME® and CELLUZYME® (Novo) are especially useful. Other suitable cellulases are also disclosed in WO 91/17243 to Novo, WO 96/34092, WO 96/34945 and EP-A-0,739,982. In practical terms for current commercial preparations, typical amounts are up to 5 mg by weight, more typically 0.01 mg to 3 mg, of active enzyme per gram of the detergent composition. Stated otherwise, the compositions herein will typically comprise from 0.001% to 5%, preferably 0.01%-1% by weight of a commercial enzyme preparation. In the particular cases where activity of the enzyme preparation can be defined otherwise such as with cellulases, corresponding activity units are preferred (e.g. CEVU or cellulase Equivalent Viscosity Units). For instance, the compositions of the present invention can contain cellulase enzymes at a level equivalent to an activity from 0.5 to 1000 CEVU/gram of composition. Cellulase enzyme preparations used for the purpose of formulating the compositions of this invention typically have an activity comprised between 1,000 and 10,000 CEVU/gram in liquid form, around 1,000 CEVU/gram in solid form.

9. Silicone Containing Agents

Silicone containing agents are useful for a variety of purposes. Silicone containing agents can be used as suds supressors during making and in use of the composition. Silicone containing materials are also useful for imparting wrinkle control benefits.

a) Silicone Suds Suppressors

Silicone compositions based on PDMS that provide suds suppression are acceptable optional ingredients for the present invention.

b) Silicones for Wrinkle Control

Although a variety of silicones are effective as wrinkle control agents, highly preferred silicones for wrinkle control are silicones or silicone emulsions wherein the silicone species comprises amines, particularly when the amines are cationically charged. Still preferred, but less so, are nuetral silicone compounds delivered as silicone emulsions comprising cationically charged emulsifiers.

Some nonlimiting examples of the highly preferred silicone compounds comprising amines are 929 Cationic Emulsion, 939 Cationic Emulsion, 949 Cationic Emulsion, 2-8194 Microemulsion available from Dow Coming as well as materials described in U.S. application Ser. No. 09/935,927 filed Aug. 23, 2001 by A. Masschelein et al. and in WO 99/32539.

When such silicone compounds are used to provide wrinkle control these are incorporated in the present composition at levels of from about 0.001% to about 10%, more preferably from about 0.1% to about 5%, and most preferably below about 2%.

10. Wrinkle Control Agents

PFSA and FSCA impart large wrinkle benefits vs. fabrics which are not treated with compositions comprising PFSA's or FSCA's. However, it is possible to boost the wrinkle control properties of compositions disclosed herein. Some compounds useful for wrinkle control are disclose below.

a) Polycationic Polymers

Polycationic polymers as disclosed above in the section entitled ‘polymers’ provide improvements in wrinkle control when used at levels disclosed above.

b) Silicone Containing Agents

Silicone containing agents disclosed above are useful in the present composition for improving wrinkle control in when used in the levels described above under section 9b.

c) Enzymes

Enzymatic compound such as those disclosed herein above and particularly cellulase and other enzymes capable of modifiying cellulosic surfaces can provide wrinkle control benefits. Not to be bound by theory, but enzymes effect wrinkle control by removing pills and irregularities from fiber surfaces thus reducing tangling and friction between fibers and thus allows wrinkles to be removed from fabrics.

11. Soil Release Agent

Particular to the embodiments of the rinse-added fabric softeners according to the present invention, certain soil release agents provide not only the below described soil release properties but are added for their suitability in maintaining proper viscosity, especially in the dispersed phase, non-isotropic compositions.

Any polymeric soil release agent known to those skilled in the art can optionally be employed in the compositions and processes of this invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of the rinsing cycle and, thus, serve as an anchor for the hydrophilic segments. This can enable stains occurring subsequent to treatment with the soil release agent to be more easily cleaned in later washing procedures.

If utilized, soil release agents will generally comprise from about 0.01% to about 10.0%, by weight, of the detergent compositions herein, typically from about 0.1% to about 5%, preferably from about 0.2% to about 3.0%.

The following, all included herein by reference, describe soil release polymers suitable for use in the present invention. U.S. Pat. No. 3,959,230 Hays, issued May 25, 1976; U.S. Pat. No. 3,893,929 Basadur, issued Jul. 8, 1975; U.S. Pat. No. 4,000,093, Nicol, et al., issued Dec. 28, 1976; U.S. Pat. No. 4,702,857 Gosselink, issued Oct. 27, 1987; U.S. Pat. No. 4,968,451, Scheibel et al., issued Nov. 6; U.S. Pat. No. 4,702,857, Gosselink, issued Oct. 27, 1987; U.S. Pat. No. 4,711,730, Gosselink et al., issued Dec. 8, 1987; U.S. Pat. No. 4,721,580, Gosselink, issued Jan. 26, 1988; U.S. Pat. No. 4,877,896, Maldonado et al., issued Oct. 31, 1989; U.S. Pat. No. 4,956,447, Gosselink et al., issued Sep. 11, 1990; U.S. Pat. No. 5,415,807 Gosselink et al., issued May 16, 1995; European Patent Application 0 219 048, published Apr. 22, 1987 by Kud, et al.

Further suitable soil release agents are described in U.S. Pat. No. 4,201,824, Violland et al.; U.S. Pat. No. 4,240,918 Lagasse et al.; U.S. Pat. No. 4,525,524 Tung et al.; U.S. Pat. No. 4,579,681, Ruppert et al.; U.S. Pat. No. 4,240,918; U.S. Pat. No. 4,787,989; U.S. Pat. No. 4,525,524; EP 279,134 A, 1988, to Rhone-Poulenc Chemie; EP 457,205 A to BASF (1991); and DE 2,335,044 to Unilever N. V., 1974 all incorporated herein by reference.

Commercially available soil release agents include the METOLOSE SM100, METOLOSE SM200 manufactured by Shin-etsu Kagaku Kogyo K.K., SOKALAN type of material, e.g., SOKALAN HP-22, available from BASF (Germany), ZELCON 5126 (from Dupont) and MILEASE T (from ICI).

A preferred soil release agent is described in U.S. Pat. No. 4,702,857 Gosselink, issued Oct. 27, 1987.

12. Presevatives

Quaternary materials such as the PFSA's and FSCA's diclosed in the present invention are effective in and of themselves as preservatives in a variety of circumstances. When additional preservative functionality is desired, materials disclosed below are nonlimiting examples of effective antimicrobial actives which are useful in the present invention:

Pyrithiones, especially the zinc complex (ZPT); Octopirox; Parabens, including Methylparaben, Propylparaben, Butylparaben, Ethylparaben, Isopropylparaben, Isobutylparaben, Benzylparaben, Sodium Methylparaben, and Sodium Propylparaben; DMDM Hydantoin (Glydant); Methylchloroisothiazolinone/methylisothiazolinone (Kathon® CG); 1,2benzisothiazolin-3-one (Proxel® GXL), Sodium Sulfite; Sodium Bisulfite; Imidazolidinyl Urea; Diazolidinyl Urea (Germail 2); Sorbic Acid/Potassium Sorbate; Dehydroacetic Acid/Sodium Dehydroacetate; Benzyl Alcohol; Sodium Borate; 2-Bromo-2-nitropropane-1,3-diol (Bronopol); Formalin; Iodopropynyl Butylcarbamate; Boric Acid; Chloroacetamide; Methenamine; Methyldibromo Glutaronitrile; Glutaraldehyde; Hexamidine Isethionate; 5-bromo-5-nitro-1,3-dioxane; Phenethyl Alcohol; o-Phenylphenol/sodium o-phenylphenol; Sodium Hydroxymethylglycinate; Polymethoxy Bicyclic Oxazolidine; Dimethoxane; Thimersol; Dichlorobenzyl alcohol; Captan; Chlorphenenesin; Dichlorophene; Chlorbutanol; Phenoxyethanol; Phenoxyisopropanol; Halogenated Diphenyl Ethers; 2,4,4′-trichloro-2′-hydroxy-diphenyl ether (Triclosan); 2,2′-dihydroxy-5,5′-dibromo-diphenyl ether; Phenolic Compounds—(including phenol and its homologs, mono- and poly-alkyl and aromatic halophenols, resorcinol and its derivatives, bisphenolic compounds and halogenated salicylanilides); Phenol and its Homologs including Phenol, 2 Methyl Phenol, 3 Methyl Phenol, 4 Methyl Phenol, 4 Ethyl Phenol, 2,4-Dimethyl Phenol, 2,5-Dimethyl Phenol, 3,4-Dimethyl Phenol, 2,6-Dimethyl Phenol, 4-n-Propyl Phenol, 4-n-Butyl Phenol, 4-n-Amyl Phenol, 4-tert-Amyl Phenol, 4-n-Hexyl Phenol, and 4-n-Heptyl Phenol; Mono- and Poly-Alkyl and Aromatic Halophenols including p-Chlorophenol, Methyl p-Chlorophenol, Ethyl p-Chlorophenol, n-Propyl p-Chlorophenol, n-Butyl p-Chlorophenol, n-Amyl p-Chlorophenol, sec-Amyl p-Chlorophenol, n-Hexyl p-Chlorophenol, Cyclohexyl p-Chlorophenol, n-Heptyl p-Chlorophenol, n-Octyl p-Chlorophenol, o-Chlorophenol, Methyl o-Chlorophenol, Ethyl o-Chlorophenol, n-Propyl o-Chlorophenol, n-Butyl o-Chlorophenol, n-Amyl o-Chlorophenol, tert-Amyl o-Chlorophenol, n-Hexyl o-Chlorophenol, n-Heptyl o-Chlorophenol, o-Benzyl p-Chlorophenol, o-benzyl-m-methyl p-Chlorophenol, o-Benzyl-m, m-dimethyl p-Chlorophenol, o-Phenylethyl p-Chlorophenol, o-Phenylethyl-m-methyl p-Chlorophenol, 3-Methyl p-Chlorophenol, 3,5-Dimethyl p-Chlorophenol, 6-Ethyl-3-methyl p-Chlorophenol, 6-n-Propyl-3-methyl p-Chlorophenol, 6-iso-Propyl-3-methyl p-Chlorophenol, 2-Ethyl-3,5-dimethyl p-Chlorophenol, 6-sec-Butyl-3-methyl p-Chlorophenol, 2-iso-Propyl-3,5-dimethyl p-Chlorophenol, 6-Diethylmethyl-3-methyl p-Chlorophenol, 6-iso-Propyl-2-ethyl-3-methyl p-Chlorophenol, 2-sec-Amyl-3,5-dimethyl p-Chlorophenol, 2-Diethylmethyl-3,5-dimethyl p-Chlorophenol, 6-sec-Octyl-3-methyl p-Chlorophenol, p-Chloro-m-cresol, p-Bromophenol, Methyl p-Bromophenol, Ethyl p-Bromophenol, n-Propyl p-Bromophenol, n-Butyl p-Bromophenol, n-Amyl p-Bromophenol, sec-Amyl p-Bromophenol, n-Hexyl p-Bromophenol, cyclohexyl p-Bromophenol, o-Bromophenol, tert-Amyl o-Bromophenol, n-Hexyl o-Bromophenol, n-Propyl-m,m-Dimethyl o-Bromophenol, 2-Phenyl Phenol, 4-Chloro-2-methyl phenol,

4-Chloro-3-methyl phenol, 4-Chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol (PCMX), 5-Chloro-2-hydroxydiphenylmethane; Resorcinol and its Derivatives including Resorcinol, Methyl Resorcinol, Ethyl Resorcinol, n-Propyl Resorcinol, n-Butyl Resorcinol, n-Amyl Resorcinol, n-Hexyl Resorcinol, n-Heptyl Resorcinol, n-Octyl Resorcinol, n-Nonyl Resorcinol, Phenyl Resorcinol, Benzyl Resorcinol, Phenylethyl Resorcinol, Phenylpropyl Resorcinol, p-Chlorobenzyl Resorcinol, 5-Chloro 2,4-Dihydroxydiphenyl Methane, 4′-Chloro 2,4-Dihydroxydiphenyl Methane, 5-Bromo 2,4-Dihydroxydiphenyl Methane, and 4′-Bromo 2,4-Dihydroxydiphenyl Methane; Bisphenolic Compounds including 2,2′-, methylene bis (4-chlorophenol), 2,2′-methylene bis (3,4,6-trichlorophenol), 2,2′-methylene bis (4-chloro-6-bromophenol), bis (2-hydroxy-3,5-dichlorophenyl) sulphide, and bis (2-hydroxy-5-chlorobenzyl)sulphide; Benzoic Esters including p-Hydroxybenzoic Acid, Methyl p-Hydroxybenzoic Acid, Ethyl p-Hydroxybenzoic Acid, Propyl p-Hydroxybenzoic Acid, and Butyl p-Hydroxybenzoic Acid.

Another class of antibacterial agents, which are useful in the present invention, are the so-called “natural” antibacterial actives, referred to as natural essential oils. These actives derive their names from their natural occurrence in plants. Typical natural essential oil antibacterial actives include oils of anise, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, Hydastis carradensis, Berberidaceae. daceae, Ratanhiae and Curcuma longa. Also included in this class of natural essential oils are the key chemical components of the plant oils which have been found to provide the antimicrobial benefit. These chemicals include, but are not limited to anethol, catechole, camphene, thymol, eugenol, eucalyptol, ferulic acid, farnesol, hinokitiol, tropolone, limonene, menthol, methyl salicylate, salicylic acid, thymol, terpineol, verbenone, berberine, ratanhiae extract, caryophellene oxide, citric acid, citronellic acid, curcumin, nerolidol, geraniol and benzoic acid.

Additional active agents are antibacterial metal salts. This class generally includes salts of metals in groups 3b-7b, 8 and 3a-5a. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium and mixtures thereof.

Preferred antimicrobial agents for use herein are the broad spectrum actives selected from the group consisting of Triclosan, phenoxyisopropanol, phenoxyethanol, PCMX, natural essential oils and their key ingredients, and mixtures thereof. The most preferred antimicrobial active for use in the present invention is Triclosan.

A wide range of quaternary compounds can also be used as antimicrobial actives, in conjunction with the preferred surfactants, for compositions of the present invention. Non-limiting examples of useful quaternary compounds include: (1) benzalkonium chlorides and/or substituted benzalkonium chlorides such as commercially available Barquat® (available from Lonza), Maquat® (available from Mason), Variquat® (available from Witco/Sherex), and Hyamine® (available from Lonza); (2) di(C₆-C₁₄)alkyl di-short chain (C₁₋₄ alkyl and/or hydroxyalkyl) quaternary such as Bardac® products of Lonza. These quaternary compounds contain two relatively short chains, e.g., C₁₋₄ alkyl and/or hydroxy alkyl groups and two C_{6-12,} preferably C_{6-10,} and more preferably C₈, alkyl groups,(3) N-(3-chloroallyl) hexaminium chlorides such as Dowicide® and Dowicil® available from Dow; (4) benzethonium chloride such as Hyamine® 1622 from Rohm & Haas; (5) methylbenzethonium chloride represented by Hyamine® 10× supplied by Rohm & Haas, (6) cetylpyridinium chloride such as Cepacol chloride available from of Merrell Labs. Examples of the preferred dialkyl quaternary compounds are didecyl dimethyl ammonium chlorid (Bardac® 2250) di(C₈-C₁₂)dialkyl dimethyl ammonium chloride, such as didecyldimethylammonium chloride (Bardac® 22), and dioctyldimethylammonium chloride (Bardac(® 2050). Typical concentrations for biocidal effectiveness of these quaternary compounds range from about 0.001% to about 0.8%, preferably from about 0.005% to about 0.3%, more preferably from about 0.01% to 0.2%, by weight of the usage composition. The corresponding concentrations for the concentrated compositions are from about 0.003% to about 2%, preferably from about 0.006% to about 1.2%, and more preferably from about 0.1% to about 0.8% by weight of the concentrated compositions.

Sanitization of fabrics can be achieved by the compositions of the present invention containing, antimicrobial materials, e.g., antibacterial halogenated compounds, quaternary compounds, and phenolic compounds.

Some of the more robust antimicrobial halogenated compounds which can function as disinfectants/sanitizers as well as finish product preservatives (vide infra), and are useful in the compositions of the present invention include 1,1′-hexamethylene bis(5-(p-chlorophenyl)biguanide), commonly known as chlorhexidine, and its salts, e.g., with hydrochloric, acetic and gluconic acids. The digluconate salt is highly water-soluble, about 70% in water, and the diacetate salt has a solubility of about 1.8% in water. When chlorhexidine is used as a sanitizer in the present invention it is typically present at a level of from about 0.001% to about 0.4%, preferably from about 0.002% to about 0.3%, and more preferably from about 0.05% to about 0.2%, by weight of the usage composition. In some cases, a level of from about 1% to about 2% may be needed for virucidal activity.

Other useful biguanide compounds include Cosmoci® CQ®, Vantocil® IB, including poly (hexamethylene biguanide) hydrochloride. Other useful cationic antimicrobial agents include the bis-biguanide alkanes. Usable water soluble salts of the above are chlorides, bromides, sulfates, alkyl sulfonates such as methyl sulfonate and ethyl sulfonate, phenylsulfonates such as p-methylphenyl sulfonates, nitrates, acetates, gluconates, and the like.

Examples of suitable bis biguanide compounds are chlorhexidine; 1,6-bis-(2-ethylhexylbiguanidohexane)dihydrochloride; 1,6-di-(N₁,N₁′-phenyldiguanido-N₅,N₅′)-hexane tetrahydrochloride; 1,6-di-(N₁,N₁′-phenyl-N₁,N₁′-methyldiguanido-N₅ ,N₅′)-hexane dihydrochloride; 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di[N₁,N₁′-.beta.-(p-methoxyphenyl)diguanido-N₅,N₅′]-hexane dihydrochloride; 1,6-di(N₁,N₁′-.alpha.-methyl-.beta.-phenyldiguanido-N₅,N₅′)-hexane dihydrochloride; 1,6-di(N₁,N₁′-p-nitrophenyldiguanido-N₅,N₅′)hexane dihydrochloride;.omega.:.omega.′-di-(N₁,N₁′-phenyldiguanido-N₅,N₅′)-di-n-propylether dihydrochloride;.omega:omega′-di(N₁,N₁′-p-chlorophenyldiguanido-N₅,N₅′)-di-n-propylether tetrahydrochloride; 1,6-di(N₁,N₁′-2,4-dichlorophenyldiguanido-N₅,N₅′)hexane tetrahydrochloride; 1,6-di(N₁,N₁′-p-methylphenyldiguanido-N₅,N₅′)hexane dihydrochloride; 1,6-di(N₁,N₁′-2,4,5-trichlorophenyldiguanido-N₅,N₅′)hexane tetrahydrochloride; 1,6-di[N₁,N₁′-.alpha.-(p-chlorophenyl)ethyldiguanido-N₅,N₅′]hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′)dodecane dihydrochloride; 1,10-di(N₁,N₁′-phenyldiguanido-N₅ ,N₅′)-decane tetrahydrochloride; 1,12-di(N₁,N₁′-phenyldiguanido-N₅,N₅′) dodecane tetrahydrochloride; 1,6-di(N₁,N₁′-o-chlorophenyldiguanido-N₅,N₅′)hexane dihydrochloride; 1,6-di(N₁,N₁′-p-chlorophenyldiguanido-N₅,N₅′)-hexane tetrahydrochloride; ethylene bis(1-tolyl biguanide); ethylene bis(p-tolyl biguanide); ethylene bis(3,5-dimethylphenyl biguanide); ethylene bis(p-tert-amylphenyl biguanide); ethylene bis(nonylphenyl biguanide); ethylene bis (phenyl biguanide); ethylene bis (N-butylphenyl biguanide); ethylene bis (2,5-diethoxyphenyl biguanide); ethylene bis(2,4-dimethylphenyl biguanide); ethylene bis(o-diphenylbiguanide); ethylene bis(mixed amyl naphthyl biguanide); N-butyl ethylene bis(phenylbiguanide); trimethylene bis(o-tolyl biguanide); N-butyl trimethylene bis(phenyl biguanide); and the corresponding pharmaceutically acceptable salts of all of the above such as the acetates; gluconates; hydrochlorides; hydrobromnides; citrates; bisulfites; fluorides; polymaleates; N-coconutalkylsarcosinates; phosphites; hypophosphites; perfluorooctanoates; silicates; sorbates; salicylates; maleates; tartrates; fumarates; ethylenediaminetetraacetates; iminodiacetates; cinnamates; thiocyanates; arginates; pyromellitates; tetracarboxybutyrates; benzoates; glutarates; monofluorophosphates; and perfluoropropionates, and mixtures thereof. Preferred antimicrobials from this group are 1,6-di-(N₁,N₁′-phenyldiguanido-N₅,N₅′)-hexane tetrahydrochloride; 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di(N₁,N₁′-2,4-dichlorophenyldiguanido-N₅,N₅′)hexane tetrahydrochloride; 1,6-di[N₁,N₁′-.alpha.-(p-chlorophenyl) ethyldiguanido-N₅,N₅′] hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′)dodecane dihydrochloride; 1,6-di(N₁,N₁′-o-chlorophenyldiguanido-N₅,N₅′)hexane dihydrochloride; 1,6-di(N₁,N₁′-p-chlorophenyldiguanido-N₅,N₅′)-hexane tetrahydrochloride; and mixtures thereof; more preferably, 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di(N₁,N₁′-2,4-dichlorophenyldiguanido-N₅,N₅′)hexane tetrahydrochloride; 1,6-di[N₁,N₁′-.alpha.-(p-chlorophenyl)ethyldiguanido-N₅,N₅′]hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′)dodecane dihydrochloride; 1,6-di(N₁,N₁′-o-chlorophenyldiguanido-N₅,N₅′)hexane dihydrochloride; 1,6-di(N₁,N₁′-p-chlorophenyldiguanido-N₅,N₅′)-hexane tetrahydrochloride; and mixtures thereof. As stated hereinbefore, the bis biguanide of choice is chlorhexidine its salts, e.g., digluconate, dihydrochloride, diacetate, and mixtures thereof.

The surfactants, when added to the antimicrobials tend to provide improved antimicrobial action. This is especially true for the siloxane surfactants, and especially when the siloxane surfactants are combined with the chlorhexidine antimicrobial actives.

Chelators, e.g., ethylenediaminetetraacetic acid (EDTA), hydroxyethylene-diaminetriacetic acid, diethylenetriaminepentaacetic acid, and other aminocarboxylate chelators, and mixtures thereof, and their salts, and mixtures thereof, can optionally be used to increase antimicrobial and preservative effectiveness against Gram-negative bacteria, especially Pseudomonas species. Although sensitivity to EDTA and other aminocarboxylate chelators is mainly a characteristic of Pseudomonas species, other bacterial species highly susceptible to chelators include Achromobacter, Alcaligenes, Azotobacter, Escherichia, Salmonella, Spirillum, and Vibrio. Other groups of organisms also show increased sensitivities to these chelators, including fungi and yeasts. Furthermore, aminocarboxylate chelators can help, e.g., maintaining product clarity, protecting fragrance and perfume components, and preventing rancidity and off odors.

Although these aminocarboxylate chelators may not be potent biocides in their own right, they function as potentiators for improving the performance of other antimicrobials/preservatives in the compositions of the present invention. Aminocarboxylate chelators can potentiate the performance of many of the cationic, anionic, and nonionic antimicrobials/preservatives, phenolic compounds, and isothiazolinones, that are used as antimicrobials/preservatives in the composition of the present invention. Nonlimiting examples of cationic antimicrobials/preservatives potentiated by aminocarboxylate chelators in solutions are chlorhexidine salts (including digluconate, diacetate, and dihydrochloride salts), and Quaternium-15, also known as Dowicil 200, Dowicide Q, Preventol D1, benzalkonium chloride, cetrimonium, myristalkonium chloride, cetylpyridinium chloride, lauryl pyridinium chloride, and the like. Nonlimiting examples of useful anionic antimicrobials/preservatives which are enhanced by aminocarboxylate chelators are sorbic acid and potassium sorbate. Nonlimiting examples of useful nonionic antimicrobials/preservatives which are potentiated by aminocarboxylate chelators are DMDM hydantoin, phenethyl alcohol, monolaurin, imidazolidinyl urea, and Bronopol(2-bromo-2-nitropropane-1,3-diol).

Examples of useful phenolic antimicrobials/preservatives potentiated by these chelators are chloroxylenol, phenol, tert-butyl hydroxyanisole, salicylic acid, resorcinol, and sodium o-phenyl phenate. Nonlimiting examples of isothiazolinone antimicrobials/preservatives which are enhanced by aminocarboxylate chelators are Kathon®, Proxel® and Promexal®.

The optional chelators are present in the compositions of this invention at levels of, typically, from about 0.01% to about 0.3%, more preferably from about 0.02% to about 0.1%, most preferably from about 0.02% to about 0.05% by weight of the usage compositions to provide antimicrobial efficacy in this invention.

Free, uncomplexed aminocarboxylate chelators are required to potentiate the efficacy of the antimicrobials. Thus, when excess alkaline earth (especially calcium and magnesium) and transitional metals (iron, manganese, copper, and others) are present, free chelators are not available and antimicrobial potentiation is not observed. In the case where significant water hardness or transitional metals are available or where product esthetics require a specified chelator level, higher levels may be required to allow for the availability of free, uncomplexed aminocarboxylate chelators to function as antimicrobial/preservative potentiators.

13. Silicone Component

The fabric softening compositions herein optionally contain an aqueous emulsion of a predominantly linear polydialkyl or alkyl aryl siloxane in which the alkyl groups can have from one to five carbon atoms and can be wholly, or partially, fluoridated. These siloxanes act to provide improved fabric benefits and reduce sudsing in processing. Suitable silicones are polydimethyl siloxanes having a viscosity, at 25° C., of from about 100 to about 100,000 centistokes, preferably from about 1,000 to about 12,000 centistokes. In some applications as low as 1 centistoke materials are preferred.

The fabric softening compositions herein can contain from about 0.1% to about 10%, of the silicone component.

14. Thickening Agent

Optionally, the fabric softening compositions herein contain from 0% to about 3%, preferably from about 0.01% to about 2%, of a thickening agent. Examples of suitable thickening agents include: cellulose derivatives, synthetic high molecular weight polymers (e.g., carboxyvinyl polymer and polyvinyl alcohol), and cationic guar gums.

The cellulosic derivatives that are functional as thickening agents herein can be characterized as certain hydroxyethers of cellulose, such as Methocel, marketed by Dow Chemicals, Inc.; also, certain cationic cellulose ether derivatives, such as Polymer JR-125, JR-400, and JR-30M, marketed by Union Carbide.

Other effective thickening agents are cationic guar gums, such as Jaguar

Plus, marketed by Stein Hall, and Gendrive 458, marketed by General Mills.

Preferred thickening agents herein are selected from the group consisting of methyl cellulose, hydroxypropyl methylcellulose, hydroxybutyl methylcellulose, or mixtures thereof, said cellulosic polymer having a viscosity in 2% aqueous solution at 20 C of from about 15 to about 75,000 centipoises.

15. Soil Release Agent

In the present invention, an optional soil release agent may be added. The addition of the soil release agent may occur in combination with the premix, in combination with the acid/water seat, before or after electrolyte addition, or after the final composition is made. The softening composition prepared by the process of the present invention herein can contain from 0% to about 10%, preferably from 0.2% to about 5%, of a soil release agent. Preferably, such a soil release agent is a polymer. Polymeric soil release agents useful in the present invention include copolymeric blocks of terephthalate and polyethylene oxide or polypropylene oxide, and the like.

A preferred soil release agent is a copolymer having blocks of terephthalate and polyethylene oxide. More specifically, these polymers are comprised of repeating units of ethylene terephthalate and polyethylene oxide terephthalate at a molar ratio of ethylene terephthalate units to polyethylene oxide terephthalate units of from 25:75 to about 35:65, said polyethylene oxide terephthalate containing polyethylene oxide blocks having molecular weights of from about 300 to about 2000. The molecular weight of this polymeric soil release agent is in the range of from about 5,000 to about 55,000.

Another preferred polymeric soil release agent is a crystallizable polyester with repeat units of ethylene terephthalate units containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials Zelcon 4780 (from Dupont) and Milease T (from ICI).

Highly preferred soil release agents are polymers of the generic formula: 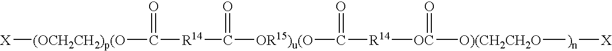
in which each X can be a suitable capping group, with each X typically being selected from the group consisting of H, and alkyl or acyl groups containing from about 1 to about 4 carbon atoms. p is selected for water solubility and generally is from about 6 to about 113, preferably from about 20 to about 50. u is critical to formulation in a liquid composition having a relatively high ionic strength. There should be very little material in which u is greater than 10. Furthermore, there should be at least 20%, preferably at least 40%, of material in which u ranges from about 3 to about 5.

The R¹⁴ moieties are essentially 1,4-phenylene moieties. As used herein, the term “the R¹⁴ moieties are essentially 1,4-phenylene moieties” refers to compounds where the R¹⁴ moieties consist entirely of 1,4-phenylene moieties, or are partially substituted with other arylene or alkarylene moieties, alkylene moieties, alkenylene moieties, or mixtures thereof. Arylene and alkarylene moieties which can be partially substituted for 1,4-phenylene include 1,3-phenylene, 1,2-phenylene, 1,8-naphthylene, 1,4-naphthylene, 2,2-biphenylene, 4,4-biphenylene, and mixtures thereof. Alkylene and alkenylene moieties which can be partially substituted include 1,2-propylene, 1,4-butylene, 1,5-pentylene, 1,6-hexamethylene, 1,7-heptamethylene, 1,8-octamethylene, 1,4-cyclohexylene, and mixtures thereof.

For the R¹⁴ moieties, the degree of partial substitution with moieties other than 1,4-phenylene should be such that the soil release properties of the compound are not adversely affected to any great extent. Generally the degree of partial substitution which can be tolerated will depend upon the backbone length of the compound, i.e., longer backbones can have greater partial substitution for 1,4-phylene moieties. Usually, compounds where the R¹⁴ comprise from about 50% to about 100% 1,4-phenylene moieties (from 0% to about 50% moieties other than 1,4-phenylene) have adequate soil release activity. For example, polyesters made according to the present invention with a 40:60 mole ratio of isophthalic (1,3-phenylene) to terephthalic (1,4-phenylene) acid have adequate soil release activity. However, because most polyesters used in fiber making comprise ethylene terephthalate units, it is usually desirable to minimize the degree of partial substitution with moieties other than 1,4-phenylene for best soil release activity. Preferably, the R¹⁴ moieties consist entirely of (i.e., comprise 100%) 1,4-phenylene moieties, i.e., each R¹⁴ moiety is 1,4-phenylene.

For the R¹⁵ moieties, suitable ethylene or substituted ethylene moieties include ethylene, 1,2-propylene, 1,2-butylene, 1,2-hexylene, 3-methoxy-1,2-propylene, and mixtures thereof. Preferably, the R¹⁵ moieties are essentially ethylene moieties, 1,2-propylene moieties, or mixtures thereof. Inclusion of a greater percentage of ethylene moieties tends to improve the soil release activity of compounds. Surprisingly, inclusion of a greater percentage of 1,2-propylene moieties tends to improve the water solubility of compounds.

Therefore, the use of 1,2-propylene moieties or a similar branched equivalent is desirable for incorporation of any substantial part of the soil release component in the liquid fabric softener compositions. Preferably, from about 75% to about 100%, are 1,2-propylene moieties.

The value for each p is at least about 6, and preferably is at least about 10. The value for each n usually ranges from about 12 to about 113. Typically the value for each p is in the range of from about 12 to about 43.

A more complete disclosure of soil release agents is contained in U.S. Pat. No. 4,661,267, Decker, Konig, Straathof, and Gosselink, issued Apr. 28, 1987; U.S. Pat. No. 4,711,730, Gosselink and Diehl, issued Dec. 8, 1987; U.S. Pat. No. 4,749,596, Evans, Huntington, Stewart, Wolf, and Zimmerer, issued Jun. 7, 1988; U.S. Pat. No. 4,818,569, Trinh, Gosselink, and Rattinger, issued Apr. 4, 1989; U.S. Pat. No. 4,877,896, Maldonado, Trinh, and Gosselink, issued Oct. 31, 1989; U.S. Pat. No. 4,956,447, Gosselink et al., issues Sept. 11, 1990; and U.S. Pat. No. 4,976,879, Maldonado, Trinh, and Gosselink, issued Dec. 11, 1990, all of said patents being incorporated herein by reference.

These soil release agents can also act as scum dispersants.

16. Scum Dispersant

In the present invention, a premix can be combined with an optional scum dispersant, other than the soil release agent, and heated to a temperature at or above the melting point(s) of the components.

The preferred scum dispersants herein are formed by highly ethoxylating hydrophobic materials. The hydrophobic material can be a fatty alcohol, fatty acid, fatty amine, fatty acid amide, amine oxide, quaternary ammonium compound, or the hydrophobic moieties used to form soil release polymers. The preferred scum dispersants are highly ethoxylated, e.g., more than about 17, preferably more than about 25, more preferably more than about 40, moles of ethylene oxide per molecule on the average, with the polyethylene oxide portion being from about 76% to about 97%, preferably from about 81% to about 94%, of the total molecular weight.

The level of scum dispersant is sufficient to keep the scum at an acceptable, preferably unnoticeable to the consumer, level under the conditions of use, but not enough to adversely affect softening. For some purposes it is desirable that the scum is nonexistent. Depending on the amount of anionic or nonionic detergent, etc., used in the wash cycle of a typical laundering process, the efficiency of the rinsing steps prior to the introduction of the compositions herein, and the water hardness, the amount of anionic or nonionic detergent surfactant and detergency builder (especially phosphates and zeolites) entrapped in the fabric (laundry) will vary. Normally, the minimum amount of scum dispersant should be used to avoid adversely affecting softening properties. Typically scum dispersion requires at least about 2%, preferably at least about 4% (at least 6% and preferably at least 10% for maximum scum avoidance) based upon the level of softener active. However, at levels of about 10% (relative to the softener material) or more, one risks loss of softening efficacy of the product especially when the fabrics contain high proportions of nonionic surfactant which has been absorbed during the washing operation.

Preferred scum dispersants are: Brij 700; Varonic U-250; Genapol T-500, Genapol T-800; Plurafac A-79; and Neodol 25-50.

17. Odor Control Agents

Odor control agents are agents that eliminate odors on fabrics and/or prevent the formation of odor on fabrics while fabrics are in storage or use between cleaning or fabric care treatments. Typical odor control agents include cyclodextrin, low molecular weight polyols, metal salts, carbonate salts, bicarbonate salts, anti-oxidants, and select enzymes can all have odor control properties. Many of these odor control agents are describe more fully in U.S. application Ser. No. 09/805,099 filed Sep. 13, 2001 by Smith et al. When incorporating an odor control agent in the present invention it is typical to use about 0.001% to about 10% of the odor control agent and preferably from about 0.001% to about 5% of the odor control agent; in the case of enzymes this level refers to the commercial preparation rather than the active compounds as in the case of all other odor control agents.

18. Other Optional Ingredients

The present invention can include optional components conventionally used in textile treatment compositions, for example, short chain alcohols such as optical brighteners, opacifiers, surfactants, stabilizers such as guar gum and polyethylene glycol, anti-shrinkage agents, fabric crisping agents, spotting agents, germicides, fungicides, anti-oxidants such as butylated hydroxy toluene, anti-corrosion agents, and the like.

### II. Methods of Use

A faric care composition based on mixed actives comprising a PFSA and a FSCA that primarily offers the benefits of fabric softening can also provide optional benefits including wrinkle control, color care, and/or improved freshness.

The compositions and articles of the present invention which contain a fabric wrinkle control agent can be used to treat fabrics, garments, household fabrics, e.g. curtains, bed spreads, pillowcases, table clothes, napkins, and the like to remove or reduce, undesirable wrinkles, provide color care and/or improve freshness in addition to the primary fabric softening benefit provided by the present compositions by use of the methods disclosed herein. The benefit of wrinkle control includes the benefits of fabrics which appear smoother after treatment and have less wrinkles and/or fabrics acquiring the the ability to resist reformation of wrinkles on storage, in-use or when left unattended in a dryer or clothes basket after treatment. Additionally wrinkle control benefits can include the benefit of making fabrics easier to iron after treatment either because there are less wrinkles after treatment and/or because it takes less force to remove wrinkles after treatment. Color care includes the benefit of improvements in the appearance of color after treatment and/or maintaining a better color appearance over time that is closer to the orignal color of the garment or the color of the garment when treatment with the present composition began. Improved freshness includes the benefits of delivering a higher than normal pleasant odor, maintaining a pleasant odor on fabrics for a longer than normal or expected time, removal of malodorants on fabrics, and/or preventing fabrics from picking up malodorants in use or storage.

Fabric Treatment with the Present Compositions

Fabrics can be treated by contacting fabrics with an aqueous bath containing an effective level of the present composition. The aqueous bath typically has a temperature from about A method of treating fabrics comprises the step of contacting the fabrics in an aqueous medium that typically has a temperature of from about 15° C. to about 60° C. containing the above softener compounds or softening composition

A typical immersion method for treating compositions of the present invention involves dispensing an effective amount of composition into the rinse cycle of a domestic or commercial washing machine. When fabrics or fibers are treated by immersion these are typically contacted with an effective amount, generally from about 5 ml to about 500 ml (per 3.5 kg of fiber or fabric being treated), or more preferably from about 20 ml to about 200 mL of the present composition compositions herein in an aqueous bath. contains from about 10 ppm to about 1000 ppm of the fabric softening actives PFSA+FSCA herein when used in the typical domestic or commercial immersion process. A method of treating fabrics comprises the step of contacting the fabrics in an aqueous medium that typically has a temperature of from about 15° C. to about 60° C. containing the above softener compounds or softening composition The compositions of the present invention are can be used in the rinse cycle of the conventional automatic laundry operations.

Fabrics or fibers are contacted with an effective amount, generally from about 20 ml to about 300 ml (per 3.5 kg of fiber or fabric being treated), of the compositions herein in an aqueous bath. Of course, the amount used is based upon the judgment of the user, depending on concentration of the softening materials, PFSA+FSCA, fiber or fabric type, degree of performance desired, and the like. Typically, from about 20 ml to about 300 ml of 9% to 40% dispersion of the softening materials PFSA+FSCA are typically used in a 25 gallon laundry rinse bath to soften and provide antistatic benefits to a 3.5 kg load of mixed fabrics. Preferably, the rinse bath contains from about 20 ppm to about 1000 ppm of the fabric softening materials PFSA+FSCA herein when used in conventional domestic processes.

While fabrics are typically treated with the present composition by immersion, there are also other acceptable methods for contacting or treating fabrics with the present composition. For instance, another means of contacting fabrics with the aqeuous bath containing the present composition is by spraying or padding the aqueous bath containing the present composition onto fabrics. When spraying the present composition onto fabrics it is typical to dilute the composition such that the final aqueous bath comprises at least about 1 aliquot of the present composition to about 1000 aliquots of water; preferably about 1 aliquot of the present composition to about 100 aliquots of water, more preferably about 2 aliquots of the present composition to about 100 aliquots of water and even more preferably 6 aliquots of the present composition to about 100 aliquots of water and typically the final aqueous bath would comprise less than about 99 aliquots of the present composition to about 1 aliquot of water and preferably less than about 50 aliquots of the present composition to about 50 aliquots of water. For padding, the aqueous bath would be composed such that the final levels of actives would be typical of those used in a commercial mill.

A method of treating fabrics by immersion comprises the step of contacting the fabrics in an aqueous medium that typically has a temperature of from about 15° C. to about 60° C. containing the above softener compounds or softening composition The compositions of the present invention are can be used in the rinse cycle of the conventional automatic laundry operations.

Fabrics or fibers are contacted with an effective amount, generally from about 20 ml to about 300 ml (per 3.5 kg of fiber or fabric being treated), of the compositions herein in an aqueous bath. Of course, the amount used is based upon the judgment of the user, depending on concentration of the softening materials, PFSA+FSCA, fiber or fabric type, degree of performance desired, and the like. Drying may be accomplished either by air drying or by contacting fabric with forced stream of cool to hot air as in a domestic or commercial drying process or for instance by using a hand held dryer or mechanical fan.

### III. Article of Manufacture

The present articles of manufacture comprise (1) a container, (2) a composition (3) a means of dispensing the composition from the container, (4) optionally a package that encompasses elements 1, 2, 3, and optional 5, and (5) optionally, but preferably a set of instructions that are typically in association with the container or packaging. The set of instructions typically communicates to the consumer of the present articles to dispense the composition in an amount effective to provide a solution to problems involving, and/or provision of a benefit related to, those selected from the group improved absorbency, wrinkle control, color care, and/or improved freshness. It is important that the consumer of the present article be aware of these benefits, since otherwise the consumer would not know that the composition would solve these problems or combination of problems and/or provide these benefits or combination of benefits.

The article of manufacture can also comprise the composition of the present invention in a container in association with a set of instructions to use the composition in an amount effective to provide a solution to problems involving and/or provision of a benefit related to those selected from the group consisting of: wrinkle control, color care, and/or improved freshness. It is important that the consumer be aware of these additional benefits, since otherwise the consumer would not know that the composition would solve these problems and/or provide these benefits.

As used herein, the phrase “in association with” means the set of instructions are either directly printed on the container itself or presented in a separate manner including, but not limited to, a brochure, print communication, electronic communication, broadcast communication and/or verbal communication, so as to communicate the set of instructions to a consumer of the article of manufacture. The set of instructions preferably comprises the instruction to add an effective amount of the composition to an aqueous bath and contact with fabrics to provide additional benefits including wrinkle control, color care, and/or improved freshness.

The set of instructions of the present articles can comprise the instruction or instructions to achieve the benefits discussed herein by carrying the methods of compositions of the present invention.

Additional Instruction for Wrinkle Control Benefits

When it is desired to dewrinkle fabrics the following additional instructions can be used. Typically it is preferred to use larger doses of the present composition when wrinkle benefits are desired. For instance, in the domestic process at least more than about 30 mL, preferably more than about 50 mLs and most preferably more than about 70 mLs of the present composition is used to treat each 3.5 kg of fabric in the aqueous bath. In terms of rinse concentration of fabric softener active, to provide wrinkle benefits it is preferably to have at least 50 ppm total PFSA+FSCA; more preferably at least about 90 ppm; even more preferably at least about 180 ppm; and most preferably about 270 ppm total PFSA+FSCA in the aqueous bath in order to provide wrinkle control benefits. Not to be bound by theory, but using higher doses imparts more lubricity to fabrics and fibers resulting in easier removal of wrinkles.

To enhance wrinkle removal, fabrics are mechanically and/or manually manipulated before the drying process is completed, including manipulation by hand, by iron, or by machine. When manipulating fabrics by hand to remove wrinkles, fabrics are manipulated while wet or still damp after partial drying. Not to be bound by theory, but water plasticizes fibers and yarns and breaks hydrogen bonds between fibers and fibrils, thus making wrinkles easier to manipulate out of fabrics. There are several manipulations that can be employed to aid in winkle control. The garments can be stretched both perpendicular and parallel to the wrinkle (or at any angle around the wrinkle) which will help to ease the wrinkle out of the clothing. Stretching the fabrics in a direction perpendicular to the line of the wrinkle is especially helpful in removing the wrinkle from clothing. The fabrics can also be smoothed using the hands with pressing and gliding motions similar to those employed with an iron. The stretching and/or smoothing procedure can be performed with the garment hung vertically, e.g., on a clothes hanger or spread on a horizontal surface, such as, a bed, an ironing board, a table surface, and the like. Another method to loosen wrinkles after treating involves shaking out fabrics with enough energy to loosen wrinkles, in some cases it may be necessary to impart enough energy to cause the fabric to make a snapping noise or motion. The wrinkles could also be manipulated out of the fabric using an implement designed to help smooth the fabrics. Such an implement would be useful in preventing contacts between hands and wrinkle controlling composition, if desired. Many fabrics or garments also contain bends in the fabrics, often termed creases or pleats, that are desireable. Such creases or pleats are often found on the front of pant legs and the sides of sleeves. These can be reinforced while the garment is being shaped to preseve the crease. Creases are reinforced by applying pressure usually by pinching the fabric either with hands or an implement and pulling the crease through the pressure point or by hanging the garment so that it folds at the crease and reinforces it with the pressure of gravity. The fabric should then be laid out flat to dry or hung on a hanger or with some other apparatus such that the fabric will remain smooth while drying. Weights can be attached to critical points on fabrics and garments to aid in maintaining smooth appearance during drying. When manual manipulations will be employed to control wrinkles that are hanging, it is optional, but convient and preferable to use a swivel clothes hanger A swivel clothes hanger has a frame that can be rotated around the stem of the hook. A fabric hung on said swivel hanger can be oriented in many directions.

When mechanical means such as a domestic or commercial dryer is used to dry fabrics, the following instructions are useful for controlling wrinkles. Preferably, for optimum dewrinkling benefit, the temperature profile inside the dryer ranges from about 40° C. to about 80° C., more preferably from about 50° C. to about 70° C. The preferred length of the drying cycle is from about 15 to about 60 minutes, more preferably from about 20 to about 45 minutes. Fabric should be removed as soon as possible, preferably immediately, following the drying cycle and arranged to maintain the smooth appearance of the fabrics with for instance, but not limited to, arranging sleeves, collars, pant legs so these are smooth and not twisted in any way, hanging the fabric on a hanger, laying the fabric flat on a or putting the fabric to its natural use to maintain its appearance e.g. hang curtains, put bed linens on the bed, put table linens on the table. Preferably the fabric will not be folded and stored until it is completely dry. It is preferable to remove fabrics before these are completely dried if it is desired to use manual manipulation as above to improve the smoothness appearance compositions using a swivel clothes hanger.

Additional Instructions for Color Care Benefits

Typically, users of compositions of the present invention will perceive the use of the composition for softening of fabrics. Normally users of compositions of the present invention will not think that such compositions can provide color care benefits in terms of color maintenance and/or prevention of color loss or color restoration unless the attention of the use is drawn to these benefits. Therefore, it is important, to make the user aware of such benefits, so that the user can derive the full benefit of the present composition.

Also, by providing the user with additional instructions in combination with the composition, the user can dervie a suprising improvement in color care benefits from compositions of the present invention. Typically, fabric softening can be derived from composition of the present invention through the use of about 1 g (fabric softener active) per kg of fabric. Now it is suprisingly found that compositions of the present invention provide improved benefits in color care by using at least abou 3 g (fabric softener active) per kg of fabric. Preferably the user should be instructed to use about 3.3 g of active per kg of fabric to about 14 g of active per kg of fabric; more preferably the use is instructed to use about 4 g of active per kg of fabric; even more preferably about 5 g active to about 12 kg of fabric; and still more preferably about 6 g of active per kg of fabric to about 10 g of active per kg of fabric.

Further instructions for the protection of fabric color include physical tasks the user can perform during the wash process to prevent fabric color appearance losses. For instance, inverting a fabric when possible (e.g. with clothes, shirts, pants, sweaters) before adding the fabric to the wash to reduce abrasion at the surface that will be shown. Another task includes reducing the load size vs. water volume to reduce likelihood of fabric to fabric rubbing and abrasion.

Additional Instructions for Odor Control Benefits.

Typically the user would not expect odor control benefits related to in-wear or in-use malodor control from such a product. When optional odor control technologies are incorporated, instructing the consumer that such benefits are available is necessary to allow the user to derive the full benefits associated with the product.

### IV. Differential Scanning Calorimetry (“DSC”) Analytical Method

Differential scanning calorimetry (DSC) is used to measure the recrystallization onset temperature of the fabric softening actives, which provides guidance as to the fluidity of the fabric softening active. Before using DSC to measure the fluidity of actives, it is necessary to freeze dry the active to remove any solvent.

DSC is a useful method for measuring the recrystallization onset temperature of the PFSA and CFSA materials. DSC is used to measure phase changes in terms of Heat Flow (W/g) as a function of Temperature (C). In this application, the phase change of interest occurs when a heated fabric softening active that is in a liquid state begins to recrystallize into a solid-semi-solid state as the active is cooled. This change is illustrated in the graphs contained in FIGS. 1-6 at numeral references 10, 20, 30, 40, 50, and 60. In general, the higher the fluidity of the fabric softener active, the lower the recrystallization onset temperature of the active material.

Measurement of the recrystallization onset temperature of a softener active is achieve via DSC analysis performed on a TA Instruments Model 2920 MDSC (A2920-465) using Thermal Advantage software (version 1.0) and a nitrogen purge of 50 mL/min. Approximately 10 mg of freeze-dried sample is run in standard-crimped Aluminum pans (one pan contains the sample, another pan remains empty) according to the following procedure: Equilibrate the sample to −20 degC, heat the sample at 10 degC/min to 80 deg C, cool the sample at 10 degC/min to −20 degC, repeat equilibration at −20 deg C, and repeat heating and cooling ramps 2 more times (total 3 cycles). The first cycle removes the thermal history of the sample, and the third cycle confirms the thermal behavior. The Thermal Advantage software will produce a graph of the resulting data, such as those shown in FIGS. 1-6.

### EXAMPLES

The following are non-limiting examples of the present invention.

Mixed active formulations are used to demonstrate the differences in absorbency performance vs single fabric softening active systems.

| Component | 1A | 1B | 1C |
|---|---|---|---|
| ST-DEEDMAC¹ | 24.7 | 0 | 0 |
| HT-DEEDMAC² | 0 | 24.7 | 0 |
| Varisoft 222³ | 0 | 0 | 24.7 |
| Varisoft 110⁴ | 0 | 0 | 0 |
| CaCl₂ | 0.545 | 0.545 | 0.545 |
| NH₄Cl | 0.1 | 0.1 | 0.1 |
| HCl | 0.0139 | 0.0139 | 0.0139 |
| DC2310⁵ | 0.015 | 0.015 | 0.015 |
| Water | balance | balance | balance |

¹Soft tallow DEEDMAC - ditallowoylethylester dimethyl ammonium chloride having recrystalization onset temperature of about 40° C.
²Hard tallow DEEDMAC - ditallowoylethylester dimethyl ammonium chloride having recrystalization onset temperature of about 65° C.
³Varisoft 222 - methyl bis(tallowamidoethyl)-2-hydroxyethyl ammonium methyl sulfate having recrystalization onset temperature of about 30° C.
⁴Varisoft 110 - methyl bis(tallowamidoethyl)-2-hydroxyethyl ammonium methyl sulfate having recrystalization onset temperature of about 56° C.
⁵Silicone emulsion used for suds suppresion available from Dow corning.

Mixed-Active Formulas 2A, 2B, 2C, and 2D are made using combinations of medium fluid (ST-DEEDMAC) and low fluid (HT-DEEDMAC) PFSA's with medium fluid (Varisoft 222) and low fluid (Varisoft 110) FSCA's.

Directional improvements in absorbency vs. single actives are found when the PFSA and the CFSA are both in the medium fluidity range with at least a 5° C. difference in the onset temperatures (e.g. Formula 2A—ST-DEEDMAC vs. Varisoft 222).

Additionally, is it possible to include fabric softener actives into concentrated mixed systems even when incorporation into single active systems fail. For instance, it is possible to formulate ST-DEEDMAC+Varisoft 110 (Formula 2C ) and HT-DEEDMAC+Varisoft 110 (Formula 2D) at 24.7% active levels even though it is not possible to make the single active system Varisoft 110 at 24.7%.

Mixed-active systems in which both the PFSA's and FSCA's are low fluid actives (e.g. Formula 2D—HT-DEEDMAC+Varisoft 110) with differences in recrystallization onset temperatures of less than 10° C. tend to perform poorly. Although this system has an advantage in absorbency, it tends to disperse poorly. Poor dispersion results in spotty coverage on fabrics, which tends to result in higher absorbency. It is desireable to have both good coverage together with higher absorbency. Therefore it is desirable that either the PFSA or the FSCA have medium fluidity.

Even a small amount of a low fluid FSCA (Varisoft 110) can significantly reduce absorbency when used with a medium fluid PFSA (ST-DEEDMAC), see Formula 2C.

| Component | 2A | 2B |
|---|---|---|
| ST-DEEDMAC | 21 | 0 |
| HT-DEEDMAC | 0 | 21 |
| Varisoft 222 | 3.7 | 3.7 |
| CaCl₂ | 0.545 | 0.545 |
| NH₄Cl | 0.1 | 0.1 |
| HCl | 0.0139 | 0.0139 |
| DC2310⁴ | 0.015 | 0.015 |
| Water | balance | balance |

The following examples show that even small amounts of a low-fluid CFSA, Varisoft 110 can seriously reduce absorbency when used with a medium-fluid PFSA.

| Component | 2C | 2D |
|---|---|---|
| ST-DEEDMAC | 21 | 0 |
| HT-DEEDMAC | 0 | 21 |
| Varisoft 110 | 3.7 | 3.7 |
| CaCl₂ | 0.545 | 0.545 |
| NH₄Cl | 0.1 | 0.1 |
| HCl | 0.0139 | 0.0139 |
| DC2310 | 0.015 | 0.015 |
| Water | balance | balance |

### Dispersibility of Mixed Actives

The following table documents the superior dispersibility possessed by compositions of the present invention. Improved dispersibility is measured by a superior ability to pass through a size exclusion filter. Not to be bound by theory, but compositions with superior dispersibility form small independent particles. Compositions that do not disperse well tend to form clumps of particles and or larger particles that do not pass through the size exclusion filter. The amount of active that is passed through the size exclusion filter is detected by titration. Formula 2D which comprises both a PFSA and CFSA of low fluidity (both are comparable to HT-DEEDMAC) tends to disperse very poorly. This poor dispersibility accounts for the unexpectedly high absorbency of Formula 2D. Poor dispersibility would leave a large area of the fabric untreated and untreated fabric is more absorbent than fabrics treated with actives having low fluidity.

### Viscosity Stability at RT and Temperature Extremes Under Static Storage Conditions

The following examples demonstrate superior viscosity stability at RT and temperatures extremes unders static stability conditions.

| Component | 4A | 4B | 4C | 4D | 4E |
|---|---|---|---|---|---|
| ST-DEEDMAC | 24.7 | 18.52 | 12.35 | 6.18 | 0 |
| Varisoft 222 | 0 | 6.18 | 12.35 | 18.52 | 24.7 |
| CaCl₂ | 0.545 | 0.545 | 0.545 | 0.545 | 0.545 |
| NH₄Cl | 0.1 | 0.1 | 0.1 | 0.1 | 0.1 |
| HCl | 0.0139 | 0.0139 | 0.0139 | 0.0139 | 0.0139 |
| DC2310 | 0.015 | 0.015 | 0.015 | 0.015 | 0.015 |
| Water | balance | balance | balance | balance | balance |

| Component | 4F | 4G | 4H |
|---|---|---|---|
| ST-DEEDMAC | 24.7 | 18.52 | 12.35 |
| Varisoft 110 | 0 | 6.18 | 12.35 |
| CaCl₂ | 0.545 | 0.545 | 0.545 |
| NH₄Cl | 0.1 | 0.1 | 0.1 |
| HCl | 0.0139 | 0.0139 | 0.0139 |
| DC2310 | 0.015 | 0.015 | 0.015 |
| Water | balance | balance | balance |

It is not possible to make a formulation with 24.7% Varisoft 110 because the composition is too high in viscosity to process effectively.

| Component | 4I | 4J | 4K | 4L | 4M | 4N | 4P |
|---|---|---|---|---|---|---|---|
| HF- | 24.7 | 0 | 12.35 | 12.35 | 11.12 | 12.35 | 12.42 |
| DEEDMAC¹ | | | | | | | |
| ST-DEEDMAC | 0 | 24.7 | 12.35 | 9.26 | 11.12 | 12.35 | 12.28 |
| Varioft 222 | 0 | 0 | 0 | 3.08 | 2.47 | 0 | 0 |
| Ethanol | 0 | 0 | 0 | 0 | 0 | 0 | 3.86 |
| CaCl₂ | 0.545 | 0.545 | 0.545 | 0.545 | 0.545 | 0.445 | 0.445 |
| HOE S 4060² | 0.25 | 0.25 | 0.25 | 0.25 | 0.25 | 0.25 | 0.25 |
| Perfume | 1.28 | 1.28 | 1.28 | 1.28 | 1.28 | 1.28 | 1.28 |
| Dye | 0.005-0.03 | 0.005-0.03 | 0.005-0.03 | 0.005-0.03 | 0.005-0.03 | 0.005-0.03 | 0.005 |
| NH₄Cl | 0.1 | 0.1 | 0.1 | 0.1 | 0.1 | 0.1 | 0.1 |
| HCl | 0.009-0.02 | 0.009-0.02 | 0.009-0.02 | 0.009-0.02 | 0.009-0.02 | 0.009-0.02 | 0.0139 |
| DC2310 | 0.015 | 0.015 | 0.015 | 0.015 | 0.015 | 0.015 | 0.015 |
| DTPA | 0 | 0 | 0 | 0.007 | 0.007 | 0.007 | 0.007 |
| Water | balance | balance | balance | balance | balance | balance | balance |

¹High fluid DEEDMAC - ditallowoylethylester dimethyl ammonium chlorid, transition temperatur = about −20° C. to about 15° C.
²Block copolymer based on terephthalate and propylene glycol available from Clariant.

All mixed active formulas except the formulation containing the combination of HT-DEEDMAC (IV=10) and Varisoft 110 (IV=10) show some improvement in static stability vs. single active formulations.

### Compositions That Pass Dynamic Freeze-Thaw Viscosity Stability

Measuring viscosity changes as a function of temperature cycling is another means by which superior formulas are identified. Since compositions are exposed to changes in temperature during shipping, storage, and usage, slowing changes in viscosity as a function of exposure to temperature changes alleviates a meaningful consumer negative. Compositions that maintain lower viscosities following temperature cycling are preferred. More preferred are compositions that maintain lower viscosities through multiple temperature cycling. None of the single active systems based on ST-DEEDMAC, HT-DEEDMAC, Varisoft 222, or Varisoft 110 can pass through one temperature cycle without reaching viscosity greater than 5000 cPs.

### Performance Benefits Derived When Highly Fluid Actives are Mixed with Medium Fluid Actives vs. Single Active Systems

Single-active compositions can have negatives that are minimized or eliminate when actives are mixed to form mixed-active compositions. Actives can be mixed to achieve a stronger overall performance profile. Absorbency benefits are gained when ST-DEEDMAC, which typically has lower absorbency, is mixed with HF-DEEDMAC.

### Improving Perfume Incorporation with Mixed Active Systems

While the high fluid active improves absorbency, it tends to reduce perfume incorporation. Mixing the high fluid active with a medium fluid active improves perfume incorporation while still maintaining a higher absorbency.

When compositions of the present invention are separated using ultrahigh centrifugation (40,000 rpm for 12 hrs.) it is typical for these composition to split into two phases. One phase comprises the vesicular lipid phase, the other phase comprises the aqueous phase. Since perfumes used in the present composition are typically lipophilic, perfume raw materials typically partition to a high degree (approximately 90%) into the lipophilic phase. Generally, the lipophilic phase is a homogeneous composition of fabric softener active and perfume. However, when highly fluid fabric softener active materials such as HF-DEEDMAC are used, perfume incorporation into the lipid phase can become a problem. Difficulties incorporating perfume into a composition such as example 4I, can be visually observed as upon making the composition, perfume tends to migrate to the surface of the vessel enclosing the composition. Additionally, when a composition such as 4I is centrifuged, the composition can be triphasic. In addition to the lipophilic phase and the aqueous phase, the lipophilic phase of a composition like 4I, is further split into a light creamy layer and another layer above the light creamy layer that appears yellow. The yellow appearance is due to the migration of perfume raw materials to the top of the lipid phase.

Analysis for perfume raw materials confirms that the split in the lipophilic phase in centrifuged formulations of 4I is due to an inability to effectively incorporate perfume in the formulation. Two samples of 4I are centrifuged. In one sample the entire lipophilic phase is analyzed for the level of perfume raw materials. In the second sample, the light creamy phase and the yellow phase are visually inspected and separated and then analysis for perfume raw materials is performed on these separated layers. The yellow phase is to be enriched by a majority of perfume raw materials vs. the entire lipid phase, showing that perfume raw materials do not distribute uniformly in compositions based on a highly fluid fabric softener active, like 4I. The failure to incorporate perfume raw materials uniformly in such compositions can lead to poor perfume deposition by such compositions and resulting poor acceptance of such products on the basis of poor aesthetics.

Compositions based on a mixture of a highly fluid active and an active with an active having lower fluidity (e.g. composition 4K) show no separation in the lipophilic layer on centrifuging. Also when such products are made, there is no perfume deposited on the surface of vessels following making. Therefore, the combination of the highly fluid fabric softener active with an active having a lower fluidity can surprisingly solve the problem associated with incorporation of perfume raw materials.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid fabric softening composition comprising:
(a) a fabric softening active system comprising a first and second softening actives, each having a recrystallization onset temperature; wherein the recrystrallization onset temperature of a first fabric softening active is at least about 5° C. below the recrystallization onset temperature of a second fabric softening active;
(b) liquid carrier to act as a continuous phase for the formation of a dispersion; and
(c) the fabric softening active system further comprises at least a third fabric softening active, wherein the third fabric softening active comprises a reduced saccharide.

2. The composition of claim 1, wherein at least one of the fabric softening actives is a quaternary ammonium compound having at least one long hydrocarbyl chain having between about 6 and about 22 carbons.

3. The composition of claim 2, wherein the quaternary ammonium compound has an iodine value of at least about 10.

4. The composition of claim 2, wherein at least about 1% of the fabric softening actives have branched hydrocarbyl chains.

5. The composition of claim 2, wherein at least about 1% of the fabric softening actives have no symmetry plane.

6. The composition of claim 2, wherein at least one of the fabric softening actives comprises one or more reaction byproducts.

7. The composition of claim 6, wherein the reaction byproducts comprise at least about 3% by weight of the fabric softening active.

8. The composition of claim 2, wherein at least one of the fabric softening actives has a molecular weight of at least about 73 as determined by taking the total MW for the active less the weight associated with the hydrocarbyl chain(s).

9. The composition of claim 2, wherein at least one of the fabric softening actives has a counter ion comprising a negative charge.

10. The composition of claim 9, wherein said counter ion is selected from the group consisting of chloride, bromide, iodide, methylsulfate, ethylsulfate, acetate, formate, sulfate, carbonate, and mixtures thereof.

11. The composition of claim 2, wherein the fabric softening active has a counter ion that comprises organic character.

12. The composition of claim 1 wherein the first and second fabric softening actives are the reaction products of methyl diethanolamine, triethanolamine, or mixtures thereof, and fatty acids, fatty oils, or mixtures thereof, to form esteramine intermediates, followed by quaternization.
